(19) United States
(12) Patent Application Publication
(10) Pub. No.: US 2026/0066310 A1
(43) Pub. Date: Mar. 5, 2026

(54) ANODE, ALL-SOLID-STATE BATTERY INCLUDING THE SAME, AND METHOD OF PREPARING THE ALL-SOLID-STATE BATTERY

(71) Applicant: Samsung Electronics Co., Ltd., Suwon-si (KR)

(72) Inventors: Jaeho SHIN, Suwon-si (KR); Kyounghwan KIM, Suwon-si (KR); Yonggun LEE, Suwon-si (KR)

(21) Appl. No.: 19/014,717

(22) Filed: Jan. 9, 2025

(30) Foreign Application Priority Data
Aug. 28, 2024 (KR) 10-2024-0115968

(51) Int. Cl. H01M 4/66; H01M 4/02; H01M 4/80; H01M 10/058

(52) U.S. Cl. CPC H01M 4/664; H01M 4/661; H01M 4/667; H01M 4/808; H01M 10/058; H01M 2004/021; H01M 2004/027

(57) ABSTRACT

An anode, an all-solid-state battery including the anode, and a method of preparing the all-solid-state battery. The anode includes a three-dimensional (3D) porous current collector including a plurality of voids having a depth H and a radius R, the voids spaced apart from one another by interval P, and an insulator layer disposed on the interval between the plurality of voids; and an interlayer disposed on the 3D porous current collector. The plurality of voids provide provide space for lithium during charge, and provide lithium during discharge, where such voids are absent of lithium before charging or after complete discharge. The plurality of voids satisfy Expression 1:

$$P \leq H \leq 50 P . \qquad Expression 1$$

### CROSS-REFERENCE TO RELATED APPLICATION

This application claims priority under 35 U.S.C. § 119 to Korean Patent Application No. 10-2024-0115968, filed on Aug. 28, 2024, in the Korean Intellectual Property Office, and all the benefits accruing therefrom under 35 U.S.C. § 119, the disclosure of which in its entirety is incorporated by reference herein.

### BACKGROUND

### 1. Field

The disclosure relates to an anode, an all-solid-state battery including the anode, and a method of preparing the all-solid-state battery.

### 2. Description of the Related Art

In general, all-solid-state batteries primarily use lithium metal as anodes. Lithium metal has a theoretical capacity of 3,861 mAh/g, which is about 10 times greater than that of graphite that is currently used as anodes in most lithium-ion batteries and has 3 times or more higher capacity per volume than graphite. Accordingly, by replacing graphene with lithium metal in an anode, one may expect relatively high energy density with the same weight/volume. Unfortunately, when lithium metal is placed in direct contact with a solid electrolyte, lithium metal shows high reactivity, and dendrite growth occurs during charging/discharging. The dendritic growth of lithium through the solid electrolyte results in deteriorating battery performance and internal short circuits that decrease battery lifetime.

For stable or long-term operation of all-solid-state batteries, further improvement and development is required in anode materials. As an example, attempts have been made to introduce an interlayer onto a lithium metal anode. However, such an anode structure causes an increase in thickness of a battery cell due to lithium plating during charging, which causes internal stress, making it difficult to obtain stable operation characteristics over an extended period of time.

Accordingly, there remains a need to develop an all-solid-state battery including an anode with a novel compositional/physical structure capable of reducing thickness or pressure variations of a cell for stable operation of an all-solid-state battery, and a method of manufacturing the all-solid-state battery.

### SUMMARY

Provided is an anode that exhibits stable operation over time and/or over many charge/discharge cycles by suppressing or minimizing a pressure variation to relatively low levels, in some instances to a pressure variation near zero, and yet, the battery exhibits minimal change to charging/discharging characteristics and/or other operating performance conditions.

Provided is an all-solid-state battery including the anode.

Provided is a method of preparing the all-solid-state battery including the anode described herein.

Additional aspects will be set forth in part in the description which follows and, in part, will be apparent from the description, or may be learned by practice of the described embodiments of the disclosure.

According to an aspect, an anode includes
a three-dimensional (3D) porous current collector including a plurality of voids having a depth H and a radius R, the voids spaced apart from one another by interval P (smallest side to side distance between voids, see, FIG. 1B), and an insulator layer disposed on the interval between the plurality of voids, and
an interlayer disposed on the 3D porous current collector,
wherein the plurality of voids provide space for lithium during charge, and provide lithium during discharge, where such voids are absent of lithium before charging or after complete discharge,
an area of the plurality of voids and a portion of the insulating layer are in contact with the interlayer,
at least a portion of the plurality of voids includes the interlayer, and
the depth H and the interval P of the plurality of voids satisfy a relationship of Expression 1 below:

$$P \leq H \leq 50 P . \qquad Expression 1$$

According to an embodiment, the insulating layer may be an insulating layer for lithium and electrons, and may include a material with an energy band gap of 3 eV or more.

According to an embodiment, the insulating layer may include at least of SiO₂, MgO, Al₂O₃, CaO, ZrSiO₄, ZrO₂, HfO₂, HfSiO₄, Y₂O₃, La₂O₃, Si₃N₄, SrO, or Ta₂O₅.

According to an embodiment, a thickness of the insulating layer may be about 5 nanometers (nm) to about 100 nm.

According to an embodiment, the depth H of the plurality of voids may be about 1 micrometer (μm) to about 90 μm.

According to an embodiment, the radius R of the plurality of voids may be about 1 μm to about 40 μm.

According to an embodiment, the interval P of the plurality of voids may be about 1 μm to about 40 μm.

According to an embodiment, the plurality of voids may have a micropattern or an array in which the voids are consistently spaced apart by interval P, and a horizontal cross-section of the micropattern has a circular, oval, triangular, square, rectangular, or hexagonal shape.

According to an embodiment, the 3D porous current collector may include copper, nickel, aluminum, stainless steel, titanium, iron, cobalt, chromium, or an alloy thereof and, other than a natural oxide layer, there may be no oxide or alloy oxide layer present on the surface of the 3D porous current collector. The term “natural oxide layer” is an oxide layer that may form naturally if the surface of the 3D porous current collector is exposed to air (oxygen), moisture during a manufacture step. In other words, the 3D porous current collector does not have a design choice oxide or alloy oxide on its surface.

According to an embodiment, the 3D porous current collector may have a foil, foam, or mesh form.

According to an embodiment, a thickness of the 3D porous current collector may be about 5 μm to about 100 μm.

According to an embodiment, the interlayer may include a mixture, complex, or combination of a carbonaceous material and one of a metal or a metalloid.

According to an embodiment, the carbonaceous material may include amorphous carbon, and the metal and the metalloid may include indium, silicon, gallium, tin, aluminum, titanium, zirconium, niobium, germanium, antimony, bismuth, gold, platinum, palladium, magnesium, silver, zinc, nickel, iron, cobalt, chromium, cesium, sodium, potassium, calcium, yttrium, tantalum, hafnium, barium, vanadium, strontium, lanthanum, or any combination (alloy) thereof.

According to an embodiment, a thickness of the interlayer may be about 1 μm to about 20 μm.

According to another aspect of the disclosure,
an all-solid-state battery includes a cathode, an anode, and a solid electrolyte interposed between the cathode and the anode, wherein the anode is the anode described above and herein.

According to an embodiment, a pressure variation of the all-solid-state secondary battery is determined during charging and discharging at 45° C. at 0.1 C in a voltage range of 2.5 V to 4.25 V. The pressure variation of the all-solid-state secondary battery may range from about 0.001 MPa to about 1.5 MPa.

According to another aspect of the disclosure, a method of preparing an all-solid-state battery includes:
applying an interlayer to a substrate and drying the interlayer to provide an interlayer structure;
forming a cathode/solid electrolyte/interlayer structure by sequentially stacking a cathode, a solid electrolyte, and an interlayer, and performing a first pressing process to the stacked structure;
providing an electroformed anode including a three-dimensional (3D) porous current collector including a plurality of voids having a depth H and a radius R, the voids spaced apart from one another by interval P, and an insulator layer disposed on the interval between the plurality of voids,
wherein the depth H and the interval P of the plurality of voids satisfy Expression 1:

$$P \leq H \leq 50 P ; \qquad Expression 1$$

removing the substrate from the cathode/solid electrolyte/interlayer structure to provide an exposed surface of the interlayer; and
arranging the electroformed anode porous with the insulator layer facing the exposed surface of the interlayer, and performing a second pressing process.

According to an embodiment, the 3D porous current collector may include a plurality of voids arranged in a micro-pattern or an array in which the voids are spaced apart (offset) by an interval P. The micropattern may be a rhombic pattern.

According to an embodiment, the first pressing process and the second pressing process may be performed by using an isostatic press, and pressure applied during the first pressing process is greater than pressure applied during the second pressing process.

According to an embodiment, the 3D porous current collector may include copper, nickel, aluminum, stainless steel, titanium, iron, cobalt, chromium, or an alloy thereof and, for an exception of a possible natural oxide layer, there may be no additional metal oxide or alloy oxide layer present on a surface of the 3D porous current collector.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a cross-section representation of an insulating layer-including three-dimensional (3D) porous current collector in an anode according to an embodiment;

FIG. 1B is a top schematic view of a 3D porous current collector in an anode according to an embodiment;

FIG. 1C is a cross-section representation of a 3D porous current collector in an anode according to an embodiment;

FIG. 2 is a schematic representation illustrating changes in voids of a 3D porous current collector of an all-solid-state secondary battery according to an embodiment during charging and discharging of the battery;

FIG. 3 is an enlarged scanning electron microscope (SEM) image of a 3D porous current collector of an anode of an all-solid-state secondary battery prepared in Example 1 before charging;

FIG. 4 are EDS images of the 3D porous current collector Ni Kα1 and Si Kα1 of FIG. 3 viewed from above;

FIG. 5 is an enlarged SEM image of an interlayer/3D porous current collector structure as an anode of the all-solid-state secondary battery prepared in Example 1 following a complete charge;

FIG. 6 are EDS images showing the interlayer/3D porous current collector structure of FIG. 5;

FIG. 7 is a plot showing results of a charging/discharging test performed on an all-solid-state secondary battery of Example 1 and the measured pressure variation;

FIG. 8 is a plot showing results of a charging/discharging test performed on an all-solid-state secondary battery of Comparative Example 1 and the measured pressure variation;

FIG. 9 is a plot showing results of a charging/discharging test performed on an all-solid-state secondary battery of Comparative Example 2 and the measured pressure variation;

FIG. 10 is a plot showing results of a charging/discharging test performed on an all-solid-state secondary battery of Comparative Example 3 and the measured pressure variation;

FIG. 11A shows the results of calculating filling quantities of plated lithium when the depth H and the inner radius R of voids are 1, 5, 10, 15, 20, 25, 30, 35, and 40, respectively, and the interval P between the voids is 1;

FIG. 11B shows the results of calculating filling quantities of plated lithium when the depth H and the inner radius R of voids are 1, 5, 10, 15, 20, 25, 30, 35, and 40, respectively, and the interval P between the voids is 5;

FIG. 11C shows the results of calculating filling quantities of plated lithium when the depth H and the inner radius R of voids are 1, 5, 10, 15, 20, 25, 30, 35, and 40, respectively, and the interval P between the voids is 10;

FIG. 11D shows results of calculating filling quantities of plated lithium when the depth H and the inner radius R of voids are 1, 5, 10, 15, 20, 25, 30, 35, and 40, respectively, and the interval P between the voids is 15;

FIG. 11E shows results of calculating filling quantities of plated lithium when the depth H and the inner radius R of voids are 1, 5, 10, 15, 20, 25, 30, 35, and 40, respectively, and the interval P between the voids is 20;

FIG. 11F shows results of calculating filling quantities of plated lithium when the depth H and the inner radius R of voids are 1, 5, 10, 15, 20, 25, 30, 35, and 40, respectively, and the interval P between the voids is 25;

FIG. 11G shows results of calculating filling quantities of plated lithium when the depth H and the inner radius R of voids are 1, 5, 10, 15, 20, 25, 30, 35, and 40, respectively, and the interval P between the voids is 30;

FIG. 11H shows results of calculating filling quantities of plated lithium when the depth H and the inner radius R of voids are 1, 5, 10, 15, 20, 25, 30, 35, and 40, respectively, and the interval P between the voids is 35; and

FIG. 11I shows results of calculating filling quantities of plated lithium when the depth H and the inner radius R of voids are 1, 5, 10, 15, 20, 25, 30, 35, and 40, respectively, and the interval P between the voids is 40.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects.

The present inventive concept of the disclosure described below allows for various changes and numerous embodiments, particular embodiments will be illustrated in the drawings and described in detail in the written description. However, this is not intended to limit the present inventive concept to particular modes of practice, and it is to be appreciated that all modifications, equivalents, and substitutes that do not depart from the spirit and technical scope of the present inventive concept are encompassed in the present inventive concept.

As used herein, the terms “an embodiment”, “embodiments”, and the like indicate that elements described with regard to an embodiment are included in at least one embodiment described in this specification and may or may not present in other embodiments. In addition, it may be understood that the described elements are combined in any suitable manner in various embodiments.

It will be understood that when an element is referred to as being “on” another element, it can be directly on the other element or intervening elements may be present therebetween. In contrast, when an element is referred to as being “directly on” another element, there are no intervening elements present.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. Therefore, reference to “an” element in a claim followed by reference to “the” element is inclusive of one element as well as a plurality of the elements.

“At least one” is not to be construed as limiting “a” or “an.” “Or” means “and/or.” As used herein, the term “and/or” includes any and all combinations of one or more of the associated listed items.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise stated, all percentages, parts, ratios, and the like are based on weight. When an amount, concentration, other value, or parameter is given as either a range, preferred range or a list of upper preferable values and/or lower preferable values, this is to be understood as specifically disclosing all ranges formed from any pair of any upper range limit or preferred value and any lower range limit or preferred value, regardless of whether ranges are separately disclosed.

Where a range of numerical values is recited herein, unless otherwise stated, the range is intended to include the endpoints thereof, and all integers and fractions within the range. The scope of the disclosure is intended not to be limited by a specific value mentioned when a range is defined.

“About” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations or within 10%, or 5% of the stated value.

Unless otherwise defined, all terms (including technical and scientific terms) used herein have the same meaning as commonly understood by one of ordinary skill in the art to which this disclosure belongs. Also, it will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments will be described herein with reference to schematic cross-sectional views of ideal embodiments. Therefore, for example, as a result of manufacturing techniques and/or tolerances, the illustrated shapes may vary. Thus, embodiments should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the actual shape of a region of a device and are not intended to limit the scope of claims.

In general, lithium is plated between an interlayer and a current collector in a interlayer-including plated anode. The plated lithium causes rapid changes in thickness and repeatedly causes changes in pressure within of a battery. A pressure variation in an electrode may cause poor contact between a solid electrolyte and an electrode active material in an interface between electrodes. As a result, a battery is likely to have micro-short circuits and deterioration of performance characteristics.

To solve the foregoing problems, the inventors describe herein an anode having a novel structure, an all-solid-state battery including the anode, and a method of preparing the all-solid-state battery.

Hereinafter, an anode having a novel structure, an all-solid-state battery including the anode, and a method of preparing the all-solid-state battery according to embodiments will be described in more detail.

An anode according to an embodiment includes a three-dimensional (3D) porous current collector including a plurality of voids having a depth H and a radius R and spaced apart from one another by interval P. The anode also includes an insulating layer, the insulating disposed on an interval between the plurality of voids, e.g., positioned proximate to the opening of the voids at a surface of the current collector. The radius is determined as the radial dimension of a circular, or near circular, void proximate to a surface of the porous current collector.

The term “radius” is generally used to describe a top-view circular shape of a void formed in the three-dimensional (3D) porous current collector. However, a person of ordinary skill in the art would understand that the void that is formed within the current collector can be of any horizontal cross-sectional shape and is not limited to a shape with a radial dimension. As described below, a horizontal slice or (a top-view), of the void may have, for example, a circular, oval, triangular, square, rectangular, or hexagonal shape. The horizontal cross-section of the pattern is not limited to just these shapes and any shape can be used as long as the void provides a volume to accommodate lithiation in the anode. Accordingly, although the term radius is used any dimensional area shape of a void can be used, and the term is not limited to defining a dimensional area of a circular or near-circular voids. Most simply, the dimensional term “radius” is a term used to determine a cross-sectional area of a void, and the area time the depth H will define a volume of the void irrespective of cross-sectional shape of the void.

For example, if the void has a horizontal cross-sectional shape of an equilateral triangle, the radial dimension R maybe one-half a length of a side of the triangle and the void would have a prismatic shape and a volume defined by the area of the triangle times the depth H. Likewise, if the void has a hexagonal cross-sectional shape, the term radius may be defined by a dimension from a midpoint to a perimeter side of the hexagon.

The 3D porous current collector according to an embodiment has a plurality of voids. The plurality of voids provide space for lithium during charge, and provide lithium during discharge, where such voids are absent of lithium before charging or after complete discharge. The plurality of voids provide a volume or space where lithium is both plated (lithiated) as well as delithiated. An area of the plurality of voids and a portion of the insulating layer are in contact with the interlayer. Moreover, at least part of the plurality of voids may include the interlayer.

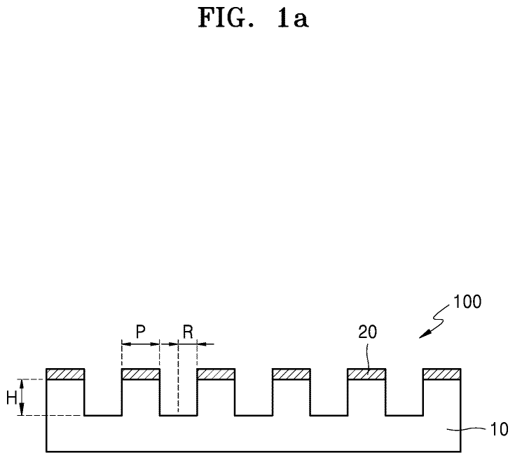

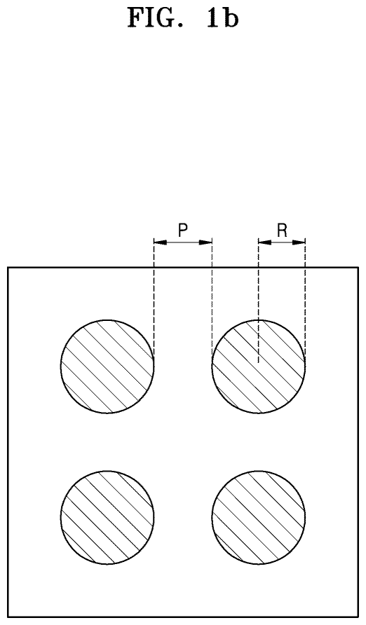

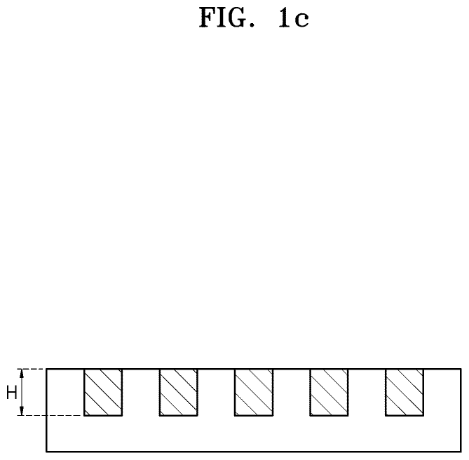

FIG. 1A is a side view detailing an insulating layer included in a 3D porous current collector in an anode according to an embodiment. FIG. 1B is a top view of a 3D porous current collector in an anode according to an embodiment. FIG. 1C is a side view of a 3D porous current collector in an anode according to an embodiment.

Referring to FIGS. 1A, 1B, and 1C, an anode according to an embodiment includes a 3D porous current collector 10 having a plurality of voids having a depth H and a radius R, the voids are spaced apart from one another by interval P. The anode also includes an insulating layer 20.

The depth H and the interval P of a plurality of voids according to an embodiment satisfy a relationship of Expression 1:

$$P \leq H \leq 50 P \qquad Expression 1$$

According to Expression 1, as indicated, the interval P between the plurality of voids is less than or equal to the depth H, generally, P is less than H. The plurality of voids provide a volume with which to accumulate and store lithium. Accordingly, an all-solid state battery in accordance with an embodiment may maintain stable operation following many charge/discharge cycles without resulting in significant volume changes of a cell during charging (lithiation). Accordingly, he all-solid-state battery may operate during charging and discharging such that an amount of internal stress of the cell is suppressed or minimized for each charge/discharge cycle and/or over time.

The depth H of the plurality of voids according to an embodiment may be about 1 μm to about 90 μm. For example, the depth H of the plurality of voids may be about 5 μm to about 90 μm, about 10 μm to about 90 μm, about 15 μm to about 90 μm, or about 20 μm to about 90 μm.

The radius R of the plurality of voids according to an embodiment may be about 1 μm to about 40 μm. For example, the inner radius R of the plurality of voids may be about 5 μm to about 40 μm, about 10 μm to about 40 μm, about 15 μm to about 40 μm, or about 20 μm to about 40 μm. In the case where a horizontal cross-section of the void is not a circle, the inner radius R refers to a length of the major axis.

The interval P of the plurality of voids according to an embodiment may be about 1 μm to about 40 μm. For example, the interval P of the plurality of voids may be about 5 μm to about 40 μm, about 10 μm to about 40 μm, about 15 μm to about 40 μm, or about 20 μm to about 40 μm.

The plurality of voids according to an embodiment may have a micro-pattern (in a form of an array) in which the voids are spaced apart at regular intervals P. The horizontal cross-section, i.e. a horizontal slice or (a top-view), of the pattern may have a circular, oval, triangular, square, rectangular, or hexagonal shape. The horizontal cross-section of the pattern is not limited to just these shapes and any shape can be used as long as the void creates a volume to accommodate lithiation in the anode. The depth H, the radius R, and the interval P of the plurality of voids and the cross-sectional shape of the pattern may be analyzed by SEM-EDS analysis which will be described below.

The insulating layer 20 according to an embodiment is an insulating layer against lithium and electrons. The insulating layer 20 may be located on an upper surface of three-dimensional (3D) porous current collector adjacent to the solid electrolyte to prevent the tip effect.

The insulating layer 20 according to an embodiment may include a material having an energy band gap of 3 eV or more.

The insulating layer 20 according to an embodiment may include at least one of SiO₂, MgO, Al₂O₃, CaO, ZrSiO₄, ZrO₂, HfO₂, HfSiO₄, Y₂O₃. La₂O₃, Si₃N₄, SrO, or Ta₂O₅.

A thickness of the insulating layer 20 according to an embodiment may be about 5 nm to about 100 nm. For example, the thickness of the insulating layer 20 may be about 10 nm to about 100 nm, about 15 nm to about 100 nm, about 20 nm to about 100 nm, about 25 nm to about 100 nm, about 30 nm to about 100 nm, about 35 nm to about 100 nm, about 40 nm to about 100 nm, about 45 nm to about 100 nm, about 50 nm to about 100 nm, about 55 nm to about 100 nm, or about 60 nm to about 100 nm. A thickness of the insulating layer 20 less than 5 nm may make it difficult to block currents due to the Tunneling Effect. A thickness of the insulating layer 20 greater than 100 nm may make it difficult to accumulate lithium in the plurality of voids during charging.

The 3D porous current collector 10 according to an embodiment may include copper, nickel, aluminum, stainless steel, titanium, iron, cobalt, chromium, or an alloy thereof. The 3D porous current collector 10 may not have a metal oxide layer or alloy oxide layer on the surface. However, the material of the 3D porous current collector 10 is not limited as described and may be any material available in the art as anode current collectors. The 3D porous current collector 10 is manufactured by an electroforming method, unlike laser drilling or punching. As a result, the 3D porous current collector 10 may realize a precise and regular pattern with 99.5% or more of metals or alloys.

The 3D porous current collector 10 according to an embodiment may have a foil, foam, or mesh form.

Although the thickness of the 3D porous current collector 10 according to an embodiment is not limited, the thickness may be, for example, about 5 μm to about 100 μm, about 10 μm to about 100 μm, or about 10 μm to about 50 μm. Within the thickness ranges of the 3D porous current collector 10 described above, an all-solid-state battery with improved energy density and lifespan characteristics may be provided.

The anode according to an embodiment includes an interlayer on the 3D porous current collector 10. The upper regions of the plurality of voids and a portion of the insulating layer 20 are in contact with the interlayer. Because the interlayer is partially in contact with the insulating layer 20, the accumulation of lithium in the plurality of voids during charging is more efficient and the tip effect may be inhibited, each of which may contribute to the minimization or suppression of pressure variations as demonstrated by an anode according to an embodiment.

At least a portion of the plurality of voids may include a portion of the interlayer. The interlayer serves as a contact area that accommodate electrons within the plurality of voids to receive electrons through inner walls of the voids on which the insulating layer is not formed during charging, resulting in the plating of lithium.

The interlayer according to an embodiment may include a mixture, a composite, or a combination of a carbonaceous material and one of a metal or a metalloid.

According to an embodiment, the carbonaceous material may include amorphous carbon, and the metal and the metalloid may include indium, silicon, gallium, tin, aluminum, titanium, zirconium, niobium, germanium, antimony, bismuth, gold, platinum, palladium, magnesium, silver, zinc, nickel, iron, cobalt, chromium, cesium, sodium, potassium, calcium, yttrium, tantalum, hafnium, barium, vanadium, strontium, lanthanum, or any combination thereof.

Examples of the amorphous carbon may include, but are not limited to, carbon black (CB), acetylene black (AB), furnace black (FB), Ketjen black (KB), graphene, carbon nanotubes, or carbon nanofibers, and any material classified as amorphous carbon in the art may be used.

The carbonaceous material may have voids. The carbonaceous material may also have voids even after discharging. Accordingly, volume expansion may be reduced during charging and discharging in carbonaceous materials having voids.

The metal and the metalloid may have a particle form. An average particle diameter D50 of a metallic material may be about 4 μm or less, about 3 μm or less, about 2 μm or less, about 1 μm or less, or about 0.5 μm or less. The lower limit of the average particle diameter (D50) is not particularly limited but may be about 10 nm or more. The average particle diameter D50 refers to a particle diameter corresponding to 50% of the particle in a cumulative distribution curve in which particles are accumulated in the order to particle diameter from the smallest particle to the largest particle and a total number of accumulated particles is 100%. The average particle diameter D50 value may be measured by any method well known in the art, for example, using a particle size analyzer, or using transmission electron microscope (TEM) or scanning electron microscope (SEM) images. In other embodiments, the D50 value may be easily obtained by measuring diameters of particles by dynamic light-scattering, counting the number of particles belonging to each particle diameter range via data analysis, and calculating the results.

In the above-described mixture or composite, a weight ratio of the carbonaceous material to the metal or the metalloid may be appropriately adjusted within a range for obtaining the necessary characteristics of all-solid-state batteries.

A thickness of the interlayer may be about 1 nm to about 10 μm, about 2 nm to about 10 μm, about 3 nm to about 10 μm, about 4 nm to about 10 μm, about 5 nm to about 10 μm, or about 6 nm to about 10 μm. Within the thickness range of the interlayer as described above, charging/discharging characteristics, such as charge/discharge efficiency and cycle characteristics, of all-solid-state batteries may be improved.

A solid electrolyte according to an embodiment is disposed on the interlayer. The solid electrolyte according to an embodiment may be an oxide-based solid electrolyte, a sulfide-based solid electrolyte, or any combination thereof.

Examples of the oxide-based solid electrolyte may include at least one of Li_{1+x+y}AlₓTi₂₋ₓSi_{y}P_{3-y}O₁₂ (wherein 0<x<2 and 0≤y<3), Li₃PO₄, LiₓTi_{y}(PO₄)₃ (wherein 0<x<2 and 0<y<3), LiₓAl_{y}Ti_{z}(PO₄)₃ (wherein 0<x<2, 0<y<1, and 0<z<3), Li_{1+x+y}(Al, Ga)ₓ(Ti, Ge)₂₋ₓSi_{y}P_{3-y}O₁₂ (wherein 0≤x≤1 and 0≤y≤1), LiₓLa_{y}TiO₃ (wherein 0<x<2 and 0<y<3), Li₂O, LiOH, Li₂CO₃, LiAlO₂, Li₂O—Al₂O₃—SiO₂—P₂O₅—TiO₂—GeO₂, and Li₃₊ₓLa₃M₂O₁₂ (wherein M=Te, Nb, or Zr, and x is an integer from 1 to 10). The oxide-based solid electrolyte is manufactured by a sintering method, or the like.

The oxide-based solid electrolyte according to an embodiment may be a Garnet-type solid electrolyte.

Non-limiting examples of the Garnet-type solid electrolyte may be an oxide represented by Formula 1 below:

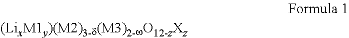

In Formula 1, 3≤x≤8, 0≤y<2, −0.2≤δ≤0.2, −0.2≤ω≤0.2, and 0≤z≤2,
M1 may be a monovalent cation, a divalent cation, a trivalent cation, or any combination thereof,
M2 may be a monovalent cation, a divalent cation, a trivalent cation, or any combination thereof,
M3 may be a monovalent cation, a divalent cation, a trivalent cation, a tetravalent cation, a pentavalent cation, a hexavalent cation, or any combination thereof, and
X may be a monovalent anion, a divalent anion, a trivalent anion, or any combination thereof.

In Formula 1, examples of the monovalent cation may be Na, K, Rb, Cs, H, or Fr, and examples of the divalent cation may be Mg, Ca, Ba, or Sr. Examples of the trivalent cation may be In, Sc, Cr, Au, B, Al, or Ga, and examples of the tetravalent cation may be Sn, Ti, Mn, Ir, Ru, Pd, Mo, Hf, Ge, V, or Si. Examples of the pentavalent cation may be Nb, Ta, Sb, V, or P.

For example, M1 may be hydrogen (H), iron (Fe), gallium (Ga), aluminum (Al), boron (B), beryllium (Be), or any combination thereof. M2 may be lanthanum (La), barium (Ba), calcium (Ca), strontium (Sr), yttrium (Y), bismuth (Bi), praseodymium (Pr), neodymium (Nd), actinium (Ac), samarium (Sm), gadolinium (Gd), or any combination thereof, and M3 may be zirconium (Zr), hafnium (Hf), tin (Sn), niobium (Nb), titanium (Ti), vanadium (V), chromium (Cr), manganese (Mn), cobalt (Co), nickel (Ni), copper (Cu), molybdenum (Mo), tungsten (W), tantalum (Ta), magnesium (Mg), technetium (Tc), ruthenium (Ru), palladium (Pd), iridium (Ir), scandium (Sc), cadmium (Cd), indium (In), antimony (Sb), tellurium (Te), thallium (Tl), platinum (Pt), silicon (Si), aluminum (AI), or any combination thereof.

In Formula 1, the monovalent anion used as X may be a halogen atom, a pseudohalogen, or any combination thereof, the divalent anion may be S²⁻ or Se²⁻, and the trivalent anion may be, for example, N³⁻.

In Formula 1, 3≤x≤8, 3.3≤x≤8, 3.6≤x≤8, 6.7≤x≤7.5, or 6.8≤x≤7.1.

Non-limiting examples of the Garnet-type solid electrolyte may include an oxide represented by Formula 2:

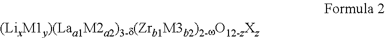

In Formula 2, M1 may be hydrogen (H), iron (Fe), gallium (Ga), aluminum (AI), boron (B), beryllium, or any combination thereof,
M2 may be barium (Ba), calcium (Ca), strontium (Sr), yttrium (Y), bismuth (Bi), praseodymium (Pr), neodymium (Nd), actinium (Ac), samarium (Sm), gallium (Gd) gadolinium (Gd), or any combination thereof,
M3 may be hafnium (Hf), tin (Sn) niobium (Nb), titanium (Ti), vanadium (V), chromium (Cr), manganese (Mn), cobalt (Co), nickel (Ni), copper (Cu), molybdenum (Mo), tungsten (W), tantalum (Ta), magnesium (Mg), technetium (Tc), ruthenium (Ru), palladium (Pd), iridium (Ir), scandium (Sc), cadmium (Cd), indium (In), antimony (Sb), tellurium (Te), thallium (Tl), platinum (Pt), silicon (Si), aluminum, or any combination thereof,

In Formula 2, 3≤x≤8, 0≤y<2, −0.2≤δ≤0.2, −0.2≤ω≤0.2, and 0≤z≤2, a1+a2=1, 0<a1≤1, and 0≤a2<1, b1+b2=1, 0<b1<1, and 0≤b2<1, and
X may be a monovalent anion, a divalent anion, a trivalent anion, or any combination thereof.

In Formula 2, 6≤x≤8.

In Formula 2, the monovalent anion used as X may be a halogen atom, a pseudohalogen, or any combination thereof, the divalent anion may be S²⁻ or Se²⁻, and the trivalent anion may be, for example, N³⁻.

In Formula 2, 3≤x≤8, 6.6≤x≤8, 6.7≤x≤7.5, or 6.8≤x≤7.1.

As used herein, the term “pseudohalogen” refers to a molecule consisting of two or more electronegative atoms similar to halogens in a free state thereof and generates anions similar to halide ions. Examples of the pseudohalogen may be cyanide, cyanate, thiocyanate, azide, or any combination thereof.

The halogen atom may be, for example, iodine (I), chlorine (Cl), bromine (Br), fluorine (F), or any combination thereof, and the pseudohalogen may be, for example, cyanide, cyanate, thiocyanate, azide, or any combination thereof.

The trivalent anion may be, for example, N³⁻.

In Formula 2, the M3 may be Al, Ga, In, Si, Ge, Sn, Sb, Bi, Sc, Y, Ti, Hf, V, Nb, Ta, W, or any combination thereof.

For example, the Garnet-type solid electrolyte may be an oxide represented by Formula 3 below:

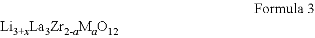

In Formula 3, M may be Al, Ga, In, Si, Ge, Sn, Sb, Bi, Sc, Y, Ti, Hf, V, Nb, Ta, W, or any combination thereof, x may be a number of 1 to 10, and 0≤a<2.

The Garnet-type solid electrolyte may be, for example, Li₇La₃Zr₂O₁₂ or Li_{6.5}La₃Zr_{1.5}Ta_{0.5}O₁₂.

Examples of the sulfide-based solid electrolyte may include at least one selected from Li₂S—P₂S₅, Li₂S—P₂S₅—LiX, wherein X is a halogen element, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ, wherein m and n are positive numbers and Z is Ge, Zn, or Ga, Li₂S—GeS₂, Li₂S—SiS₂—Li₃PO₄, Li₂S—SiS₂-LiₚMO_{q}, wherein p and q are positive numbers and M is P, Si, Ge, B, Al, Ga, or In, Li₇₋ₓPS₆₋ₓClₓ, wherein 0≤x≤2, Li₇₋ₓPS₆₋ₓBrₓ, wherein 0≤x≤2, and Li₇₋ₓPS₆₋ₓIₓ, wherein 0≤x≤2. The sulfide-based solid electrolyte may be prepared by treating a starting material such as Li₂S and P₂S₅ by melt quenching or mechanical milling. Heat treatment may be performed after such treatment. The sulfide-based solid electrolyte may be in an amorphous or crystalline form or in a mixed form thereof.

For example, the solid electrolyte may include at least sulfur(S), phosphorus (P), and lithium (Li) as components among the above-described materials for the sulfide-based solid electrolyte. For example, the sulfide-based solid electrolyte may be a material including Li₂S—P₂S₅. In the case of using the material including Li₂S—P₂S₅ as the sulfide-based solid electrolyte, a mixing molar ratio of Li₂S to P₂S₅ (Li₂S:P₂S₅) may be, for example, about 50:50 to about 90:10.

For example, the sulfide-based solid electrolyte may be a sulfide represented by Formula 4 below:

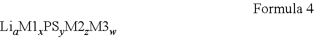

In Formula 4, M1 refers to at least one metallic element, other than Li, selected from Group 1 elements to Group 15 elements of the periodic table, and M2 refers to at least one element selected from Group 17 elements of the periodic table,
M3 is SOₙ, and 4≤a≤8, 0≤x<1, 3≤y≤7, 0<z≤5, 0≤w<2, and 1.5≤n≤5.

“Group” may refer to a group of elements in the periodic table numbered from 1 to 18 classified according to a classification system of The International Union of Pure and Applied Chemistry (“IUPAC”).

In Formula 4, 0<z≤5, 0<z≤4, 0<z≤3, 0<z≤2, 0.2≤z≤1.8, 0.5≤z≤1.8, 1.0≤z≤1.8, or 1.0≤z≤1.5.

In Formula 4, 5≤a≤8, 0≤x≤0.7, 4≤y≤7, 0<z≤2, and 0≤w≤0.5. For example, 5≤a≤7, 0≤x≤0.5, 4≤y≤6, 0<z≤2, and 0≤w≤0.2. For example, 5.5≤a≤7, 0≤x≤0.3, 4.5≤y≤6, 0.2≤z≤1.8, and 0≤w≤0.1. For example, 5.5≤a≤6, 0≤x≤0.05, 4.5≤y≤5, 1.0≤z≤1.5, and 0≤w≤0.1.

In Formula 4, M1 may include Na, K, Mg, Ag, Cu, Hf, In, Ti, Pb, Sb, Fe, Zr, Zn, Cr, B, Sn, Ge, Si, Zr, Ta, Nb, V, Ga, Al, As, or any combination thereof. M1 may be, for example, a monovalent cation or a divalent cation.

In Formula 4, M2 may include F, Cl, Br, I or any combination thereof. M2 may be, for example, a monovalent anion.

In Formula 4, SOₙ of M3 may be S₄O₆, S₃O₆, S₂O₃, S₂O₄, S₂O₅, S₂O₆, S₂O₇, S₂O₈, SO₄, SO₅, or any combination thereof. For example, SOₙ may be a divalent anion. For example, SOₙ²⁻ may be, for example, S₄O₆²⁻, S₃O₆²⁻, S₂O₃²⁻, S₂O₄²⁻, S₂O₅²⁻, S₂O₆²⁻, S₂O₇²⁻, S₂O₈²⁻, SO₄²⁻, SO₅²⁻, or any combination thereof.

The compound represented by Formula 4 may be, for example, a compound selected from compounds represented by Formulae 4a to 4b below:

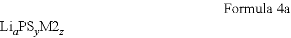

In Formula 4a, M2 refers to at least one element selected from Group 17 elements of the periodic table, and 4≤a≤8, 3≤y≤7, and 0<z≤5.

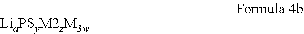

In Formula 4b, M2 refers to at least one element selected from Group 17 elements of the periodic table, M3 is SOn, and 4≤a≤8, 3≤y≤7, 0<z≤5, 0<w<2, and 1.5≤n≤5.

In Formulae 4a or 4b, 0<z≤5, 0<z≤4, 0<z≤3, 0<z≤2, 0.2≤z≤1.8, 0.5≤z≤1.8, 1.0≤z≤1.8, or 1.0≤z≤1.5.

In Formulae 4a or 4b, for example, 5≤a≤8, 4≤y≤7, 0<z≤2, and 0≤w≤0.5, 5.5≤a≤7, 4.5≤y≤6, 0.2≤z≤1.8, and 0≤w≤0.1, 0.5≤z≤1.8, or 1.0≤z≤1.8.

The compound represented by Formula 4 may be, for example, a compound represented by Formula 5.

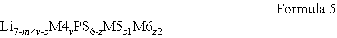

In Formula 5, M4 is Na, K, Mg, Ag, Cu, Hf, In, Ti, Pb, Sb, Fe, Zr, Zn, Cr, B, Sn, Ge, Si, Ta, Nb, V, Ga, Al, As, or any combination thereof, m is an oxidation state of M4, M5 and M6 are each independently F, Cl, Br, or I, and 0<v<0.7, 0<z1<2, 0≤z2<1, 0<z<2, z=z1+z2, and 1≤m≤2.

For example, 0<v≤0.7, 0<z1<2, 0≤z2≤0.5, 0<z<2, and z=z1+z2. For example, 0<v≤0.5, 0<z1<2, 0≤z2≤0.5, 0<z<2, and z=z1+z2. For example, 0<v≤0.3, 0<z1≤1.5, 0≤z2≤0.5, 0.2≤z≤1.8, and z=z1+z2. For example, 0<v≤0.1, 0<z1≤1.5, 0≤z2≤0.5, 0.5≤z≤1.8, and z=z1+z2. For example, 0<v≤0.05, 0<z1≤1.5, 0≤z2≤0.2, 1.0≤z≤1.8, and z=z1+z2. For example, M4 may be one metal element or may include two metal elements.

The compound represented by Formula 5 may include, for example, one halogen element or two halogen elements.

The compound represented by Formula 4 may be, for example, a solid ion conductor compound represented by one of Formulae 5a to 5f:

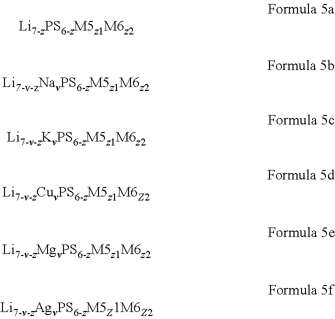

In the formulae, M5 and M6 are each independently F, Cl, Br, or I, and 0<v≤0.7, 0<z1<2, 0≤z2<1, 0<z<2, and z=z1+z2.

Formulae 5a to 5f each independently satisfy, for example, 0<v<0.7, 0<z1<2, 0≤z2≤0.5, 0<z<2, and z=z1+z2, 0<v≤0.5, 0<z1<2, 0≤z2≤0.5, 0<z<2, and z=z1+z2, 0<v≤0.3, 0<z1≤1.5, 0≤z2≤0.5, 0.2≤z≤1.8, and z=z1+z2, 0<v≤0.05, 0<z1≤1.5, 0≤z2≤0.2, 1.0≤z≤1.8, and z=z1+z2, for example, 0<v≤0.05, 0<z1≤1.5, 0≤z2≤0.2, 1.0≤z≤1.5, and z=z1+z2. In Formula 5a, v=0.

The compound represented by Formula 4 may be, for example, one of the compounds represented by the following formulae:
Li_{7-z}PS_{6-z}F_{z1}, Li_{7-z}PS_{6-z}Cl_{z1}, Li_{7-z}PS_{6-z}Br_{z1}, Li_{7-z}PS_{6-z}I_{z1}, Li_{7-z}PS_{6-z}F_{z1}Cl_{z2}, Li_{7-z}PS_{6-z}F_{z1}Br_{z2}, Li_{7-z}PS_{6-z}F_{z1}I_{z2}, Li_{7-z}PS_{6-z}Cl_{z1}Br_{z2}, Li_{7-z}PS_{6-z}Cl_{z1}I_{z2}, Li_{7-z}PS_{6-z}Cl_{z1}F_{z2}, Li_{7-z}PS_{6-z}Br_{z1}I_{z2}, Li_{7-z}PS_{6-z}Br_{z1}F_{z2}, Li_{7-z}PS_{6-z}Br_{z1}Cl_{z2}, Li_{7-z}PS_{6-z}I_{z1}F_{z2}, Li_{7-z}PS_{6-z}I_{z1}Cl_{z2}, Li_{7-z}PS_{6-z}I_{z1} Br_{z2}Li_{7-v-z}NaᵥPS_{6-z}F_{z1}, Li_{7-v-z}NaᵥPS_{6-z}Cl_{z1}, Li_{7-v-z}NaᵥPS_{6-z}Br_{z1}, Li_{7-v-z}NaᵥPS_{6-z}I_{z1}, Li_{7-v-z}NaᵥPS_{6-z}F_{z1}Cl_{z2}, Li_{7-v-z}NaᵥPS_{6-z}F_{z1}Br_{z2}, Li_{7-v-z}NaᵥPS_{6-z}F_{z1}I_{z2}, Li_{7-v-z}NaᵥPS_{6-z}Cl_{z1}Br_{z2}, Li_{7-v-z}NaᵥPS_{6-z}Cl_{z1}I_{z2}, Li_{7-v-z}NaᵥPS_{6-z}Cl_{z1}F_{z2}, Li_{7-v-z}NaᵥPS_{6-z}Br_{z1}I_{z2}, Li_{7-v-z}NaᵥPS_{6-z}Br_{z1}F_{z2}, Li_{7-v-z}NaᵥPS_{6-z}Br_{z1}Cl_{z2}, Li_{7-v-z}NaᵥPS_{6-z}I_{z1}F_{z2}, Li_{7-v-z}NaᵥPS_{6-z}I_{z1}Cl_{z2}, Li_{7-v-z}NaᵥPS_{6-z}I_{z1}Br_{z2}, Li_{7-v-z}KᵥPS_{6-z}F_{z1}, Li_{7-v-z}KᵥPS_{6-z}Cl_{z1}, Li_{7-v-z}KᵥPS_{6-z}Br_{z1}, Li_{7-v-z}KᵥPS_{6-z}I_{z1},
Li_{7-v-z}KᵥPS_{6-z}F_{z1}Cl_{z2}, Li_{7-v-z}KᵥPS_{6-z}F_{z1}Br_{z2}, Li_{7-v-z}KᵥPS_{6-z}F_{z1}I_{z2}, Li_{7-v-z}KᵥPS_{6-z}Cl_{z1}Br_{z2}, Li_{7-v-z}KᵥPS_{6-z}Cl_{z1}I_{z2}, Li_{7-v-z}KᵥPS_{6-z}Cl_{z1}F_{z2}, Li_{7-v-z}KᵥPS_{6-z}Br_{z1}I_{z2}, Li_{7-v-z}KᵥPS_{6-z}Br_{z1}F_{z2}, Li_{7-v-z}KᵥPS_{6-z}Br_{z1}Cl_{z2}, Li_{7-v-z}KᵥPS_{6-z}I_{z1}F_{z2}, Li_{7-v-z}KᵥPS_{6-z}I_{z1}Cl_{z2}, Li_{7-v-z}KᵥPS_{6-z}I_{z1}Br_{z2},
Li_{7-v-z}CuᵥPS_{6-z}F_{z1}, Li_{7-v-z}CuᵥPS_{6-z}Cl_{z1}, Li_{7-v-z}CuᵥPS_{6-z}Br_{z1}, Li_{7-v-z}CuᵥPS_{6-z}I_{z1}, Li_{7-v-z}CuᵥPS_{6-z}F_{z1}Cl_{z2}, Li_{7-v-z}CuᵥPS_{6-z}F_{z1}Br_{z2}, Li_{7-v-z}CuᵥPS_{6-z}F_{z1}I_{z2}, Li_{7-v-z}CuᵥPS_{6-z}Cl_{z1}Br_{z2}, Li_{7-v-z}CuᵥPS_{6-z}Cl_{z1}I_{z2}, Li_{7-v-z}CuᵥPS_{6-z}Cl_{z1}F_{z2}, Li_{7-v-z}CuᵥPS_{6-z}Br_{z1}I_{z2}, Li_{7-v-z}CuᵥPS_{6-z}Br_{z1}F_{z2}, Li_{z-v-z}CuᵥPS_{6-z}Br_{z1}Cl_{z2}, Li_{7-v-z}CuᵥPS_{6-z}I_{z1}F_{z2}, Li_{7-v-z}CuᵥPS_{6-z}I_{z1}Cl_{z2}, Li_{7-v-z}CuᵥPS_{6-z}I_{z1}Br_{z2},
Li_{7-2v-z}MgᵥPS_{6-z}F_{z1}, Li_{7-2v-z}MgᵥPS_{6-z}Cl_{z1}, Li_{7-2v-z}MgᵥPS_{6-z}Br_{z1}, Li_{7-2v-z}MgᵥPS_{6-z}I_{z1},
Li_{7-2v-z}MgᵥPS_{6-z}F_{z1}Cl_{z2}, Li_{7-2v-z}MgᵥPS_{6-z}F_{z1}Br_{z2}, Li_{7-2v-z}MgᵥPS_{6-z}Cl_{z1}Br_{z2}, Li_{7-2v-z}MgᵥPS_{6-z}Cl_{z1}I_{z2}, Li_{7-2v-z}MgᵥPS_{6-z}Cl_{z1}F_{z2}, Li_{7-2v-z}MgᵥPS_{6-z}Br_{z1}I_{z2}, Li_{7-2v-z}MgᵥPS_{6-z}Br_{z1}F_{z2}, Li_{7-2v-z}MgᵥPS_{6-z}Br_{z1}Cl_{z2}, Li_{7-2v-z}MgᵥPS_{6-z}I_{z1}F_{z2}, Li_{7-2v-z}MgᵥPS_{6-z}I_{z1}Cl_{z2}, Li_{7-2v-z}MgᵥPS_{6-z}I_{z1}Br_{z2},
Li_{7-v-z}AgᵥPS_{6-z}F_{z1}, Li_{7-v-z}AgᵥPS_{6-z}Cl_{z1}, Li_{7-v-z}AgᵥPS_{6-z}Br_{z1}, Li_{7-v-z}AgᵥPS_{6-z}I_{z1}, Li_{7-v-z}AgᵥPS_{6-z}F_{z1}Cl_{z2}, Li_{7-v-z}AgᵥPS_{6-z}F_{z1}Br_{z2}, Li_{7-v-z}AgᵥPS_{6-z}F_{z1}I_{z2}, Li_{7-v-z}AgᵥPS_{6-z}Cl_{z1}Br_{z2}, Li_{7-v-z}AgᵥPS_{6-z}Cl_{z1}I_{z2}, Li_{7-v-z}AgᵥPS_{6-z}Cl_{z1}F_{z2}, Li_{7-v-z}AgᵥPS_{6-z}Br_{z1}I_{z2}, Li_{7-v-z}AgᵥPS_{6-z}Br_{z1}F_{z2}, Li_{7-v-z}AgᵥPS_{6-z}Br_{z1}Cl_{z2}, Li_{7-v-z}AgᵥPS_{6-z}I_{z1}F_{z2}, Li_{7-v-z}AgᵥPS_{6-z}I_{z1}Cl_{z2}, and Li_{7-v-z}AgᵥPS_{6-z}I_{z1}Br_{z2}.

The formulae each independently satisfy 0<v≤0.7, 0<z1<2, 0<z2<1, 0<z<2 and z=z1+z2, for example, 0<v≤0.7, 0<z1<2, 0<z2≤0.5, 0<z<2, and z=z1+z2, 0<v≤0.3, 0<z1≤1.5, 0<z2≤0.5, 0.2≤z≤1.8 and z=z1+z2, 0<v≤0.05, 0<z1≤1.5, 0<z2≤0.2, 1.0≤z≤1.8, and z=z1+z2, or 0<v≤0.05, 0<z1≤1.5, 0<z2≤0.2, 1.0≤z≤1.5, and z=z1+z2. When v, z1, or z2 is absent in the formulae, v=0, z1=0, or z2=0. For example, when z1=0, z=z2. For example, when z2=0, z=z1.

The compound represented by Formula 4 may belong to, for example, a cubic crystal system, and more specifically, a F-43m space group. In addition, as described above, the compound represented by Formula 1 may be an argyrodite-type sulfide having an argyrodite-type crystal structure. The compound represented by Formula 4 may include at least one of a monovalent cation and a divalent cation substituting the lithium sites, a hetero-halogen element, or SOₙ anion substituting the halogen site, thereby further improving lithium ion conductivity and electrochemical stability against lithium metal.

The compound represented by Formula 4 is, for example, Li₆PS₅Cl.

Throughout the specification, the sulfide-based solid electrolyte may be an argyrodite-type compound including at least one selected from Li₇₋ₓPS₆₋ₓClₓ, wherein 0≤x≤2, Li₇₋ₓPS₆₋ₓBrₓ, wherein 0≤x≤2, and Li₇₋ₓPS₆₋ₓIₓ, wherein 0≤x≤2. The sulfide-based solid electrolyte contained in the solid electrolyte may be an argyrodite-type compound including at least one selected from Li₆PS₅Cl, Li₆PS₅Br, and Li₆PS₅I.

The sulfide-based solid electrolyte may be in the form of powder or a molded product. The solid electrolyte in the form of a molded product may be, for example, in a pellet, sheet, or thin-film form, but is not limited thereto, and may be in various forms depending on the intended use.

The solid electrolyte may further include, for example, a binder. The binder included in a solid electrolyte layer 30 may be, for example, styrene butadiene rubber (SBR), polytetrafluoroethylene, polyvinylidene fluoride, or polyethylene, but is not limited thereto, and may be any binder used in the art. The binder of the solid electrolyte may be the same as or different from a binder of a cathode active material layer and a binder of an anode active material layer.

### All-Solid-State Battery

An all-solid-state battery according to another embodiment may include a cathode, an anode, and a solid electrolyte disposed between the cathode and the anode, wherein the anode may be the above-described anode. The anode and the solid electrolyte are as described above, and thus descriptions thereof will be omitted.

The all-solid-state battery may include a thin-film laminated battery, a multi-layer ceramic battery, a lithium-sulfur battery, or a lithium-air battery. For example, the all-solid-state battery may be an all-solid-state secondary battery.

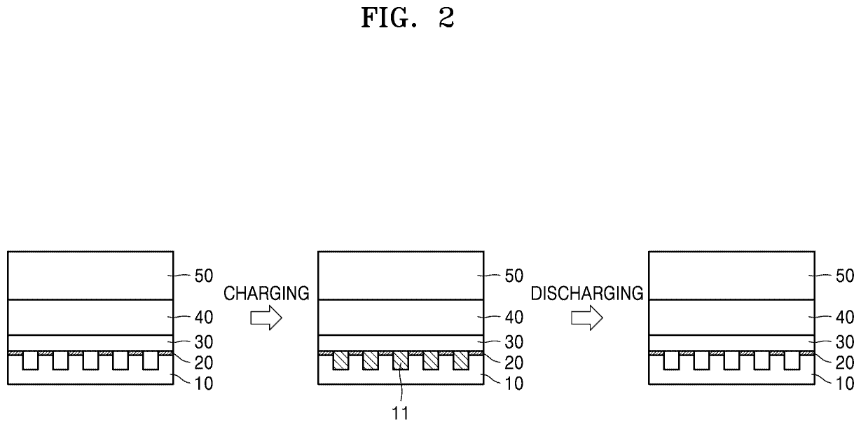

FIG. 2 is a schematic view illustrating changes in voids of a 3D porous current collector of an all-solid-state secondary battery according to an embodiment during charging and discharging.

Referring to FIG. 2, before charging and after discharging (after completely discharging), a 3D porous current collector 10 including a plurality of voids and an insulating layer 20, an interlayer 30, and a solid electrolyte 40 are sequentially stacked. In the all-solid-state secondary battery, a cathode 50 is disposed on the solid electrolyte 40 of the anode. After charging, the anode includes lithium 11 plated in the plurality of voids in the 3D porous current collector 10.

A pressure variation of the all-solid-state secondary battery during charging and discharging at 45° C. at 0.1 C in a voltage range of 2.5 V to 4.25 V may be about 0.001 MPa to about 1.5 MPa, about 0.001 MPa to about 1 MPa, or about 0.001 MPa to about 0.8 MPa. That is, little or almost no pressure variation is observed during charging and discharging of the all-solid-state secondary battery.

The cathode 50 includes a cathode current collector and a cathode active material layer.

As the cathode current collector, a metal substrate may be used. Examples of the metal substrate may be aluminum (AI), indium (In), copper (Cu), magnesium (Mg), stainless steel, titanium (Ti), iron (Fe), cobalt (Co), nickel (Ni), zinc (Zn), germanium (Ge), lithium (Li), or any alloy thereof. The cathode current collector may be in the form of a plate or foil. The cathode current collector may be omitted.

Any cathode active materials commonly available in lithium batteries may be used without limitation. For example, the cathode active material may include at least one composite oxide of lithium and a metal selected from cobalt, manganese, nickel, and any combination thereof, and examples thereof may be a compound represented by one of the following formulae: LiₐA_{1-b}B′_{b}D′₂ (wherein 0.90≤a≤1.8 and 0≤b≤0.5); LiₐE_{1-b}B′_{b}O_{2-c}D′_{c} (wherein 0.90≤a≤1.8, 0≤b≤0.5, and 0≤c≤0.05); LiE_{2-b}B′_{b}O_{4-c}D′_{c} (wherein 0≤b≤0.5 and 0≤c≤0.05); LiₐNi_{1-b-c}Co_{b}B′_{c}D′_{α} (wherein 0.90≤a≤1.8, 0≤b≤0.5, 0≤c≤0.05, and 0<α≤2); LiₐNi_{1-b-c}Co_{b}B′_{c}O_{2-α}F′_{α} (wherein 0.90≤a≤1.8, 0≤b≤0.5, 0≤c≤0.05, and 0<α<2); LiₐNi_{1-b-c}Co_{b}B′_{c}O_{2-α}F′₂ (wherein 0.90≤a≤1.8, 0≤b≤0.5, 0≤c≤0.05, and 0<α<2); LiₐNi_{1-b-c}Mn_{b}B′_{c}D′_{α} (wherein 0.90≤a≤1.8, 0≤b≤0.5, 0≤c≤0.05, and 0<α≤2); LiₐNi_{1-b-c}Mn_{b}B′_{c}O_{2-α}F′_{α} (wherein 0.90≤a≤1.8, 0≤b≤0.5, 0≤c≤0.05, and 0<α<2); LiₐNi_{1-b-c}Mn_{b}B′_{c}O_{2-α}F′₂ (wherein 0.90≤a≤1.8, 0≤b≤0.5, 0≤c≤0.05, and 0<α<2); LiₐNi_{b}E_{c}G_{d}O₂ (wherein 0.90≤a≤1.8, 0≤b≤0.9, 0≤c≤0.5, and 0.001≤d≤0.1); LiₐNi_{b}Co_{c}Mn_{d}GeO₂ (wherein 0.90≤a≤1.8, 0≤b≤0.9, 0≤c≤0.5, 0≤d≤0.5, and 0.001≤e≤0.1); LiₐNiG_{b}O₂ (wherein 0.90≤a≤1.8 and 0.001≤b≤0.1); LiₐCoG_{b}O₂ (wherein 0.90≤a≤1.8 and 0.001≤b≤0.1); LiₐMnG_{b}O₂ (wherein 0.90≤a≤1.8 and 0.001≤b≤0.1); LiₐMn₂G_{b}O₄ (wherein 0.90≤a≤1.8 and 0.001≤b≤0.1); QO₂; QS₂; LiQS₂; V₂O₅; LiV₂O₂; LiI′O₂; LiNiVO₄; Li_{(3-f)}J₂(PO₄)₃ (wherein 0≤f≤2); Li_{(3-f)}Fe₂(PO₄)₃ (wherein 0≤f≤2); and LiFePO₄. In the compounds, A is Ni, Co, Mn, or any combination thereof; B′ is Al, Ni, Co, Mn, Cr, Fe, Mg, Sr, V, a rare earth element, or any combination thereof; D′ is O, F, S, P, or any combination thereof; E is Co, Mn, or any combination thereof; F′ is F, S, P, or any combination thereof; G is Al, Cr, Mn, Fe, Mg, La, Ce, Sr, V, or any combination thereof; Q is Ti, Mo, Mn, or any combination thereof; I′ is Cr, V, Fe, Sc, Y, or any combination thereof; and J is V, Cr, Mn, Co, Ni, Cu, or any combination thereof. For example, the cathode active material may include at least one selected from a lithium cobalt oxide, a lithium nickel oxide, a lithium nickel cobalt oxide, a lithium nickel cobalt aluminum oxide, a lithium nickel cobalt manganese oxide, a lithium manganese oxide, a lithium iron phosphate oxide, a nickel sulfide, a copper sulfide, a lithium sulfide, an iron oxide, and an vanadium oxide. For example, the cathode active material may be LiCoO₂, LiMnₓO₂ₓ (wherein x=1 and 2), LiNi₁₋ₓMnₓO₂ₓ (wherein 0<x<1), Ni_{1-x-y}CoₓMn_{y}O₂ (wherein 0≤x≤0.5 and 0≤y≤0.5), LiNi_{1-x-y}MnₓAl_{y}O₂ (wherein 0<x<1 and 0<y<1), LiFePO₄, TiS₂, FeS₂, TiS₃, or FeS₃.

For example, the cathode active material includes a lithium salt of a transition metal oxide having a layered rock-salt type structure in a lithium transition metal oxide. The “layered rock-salt type structure” refers to a structure in which an oxygen atom layer and a metal atom layer are alternately and regularly arranged in a <111> direction in the cubic rock-salt type structure, so that each of the atom layers forms a two-dimensional flat plane. The “cubic rock-salt type structure” refers to a sodium chloride (NaCl) type structure, which is one of the crystalline structures, e.g., a structure in which face-centered cubic (fcc) lattices respectively formed of cations and anions are shifted by only a half of the ridge of each unit lattice. Examples of the lithium transition metal oxide having the layered rock-salt type structure may include a ternary lithium transition metal oxide expressed as such as LiNiₓCo_{y}Al_{z}O₂ (NCA) or LiNiₓCo_{y}Mn_{z}O₂ (NCM) (wherein 0<x<1, 0<y<1, 0<z<1, and x+y+z=1). When the cathode active material includes a ternary lithium transition metal oxide having the layered rock-salt type structure, energy density and thermal stability of the all-solid-state secondary battery may further be improved.

The cathode active material may be covered with a coating layer. The coating layer may be formed of any material commonly used for coating layers of cathode active materials of all-solid-state secondary batteries. The coating layer may be, for example, Li₂O—ZrO₂.

When the cathode active material includes a ternary lithium transition metal oxide containing nickel (Ni) such as NCA or NCM, metal elution from the cathode active material in a charged state may be reduced by increasing a capacity density of the all-solid-state secondary battery. As a result, the all-solid-state secondary battery may have improved cycle characteristics in a charged state.

The cathode active material may have a particle shape, for example, a true spherical shape or an elliptical shape. The particle diameter of the cathode active material is not particularly limited and may be within a range applicable to cathode active materials of conventional all-solid-state secondary batteries. An amount of the cathode active material of the cathode 50 is not limited and may be in a suitable range applicable to the cathode 50 of common all-solid-state secondary batteries.

The cathode active material layer may further include an ionic liquid electrolyte. The ionic liquid electrolyte may be non-volatile. The ionic liquid may refer to a salt in a liquid state at room temperature composed solely of ions and having a melting point below room temperature or a molten salt at room temperature. The ionic liquid may include at least one of the compounds including a) at least one cation selected from ammonium, pyrrolidinium, pyridinium, pyrimidium, imidazolium, piperidinium, pyrazolium, oxazolium, pyridazinium, phosphonium, sulfonium, triazolium, and any mixture thereof, and b) at least one anion selected from BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, SO₄⁻, CF₃SO₃⁻, (FSO₂)₂N⁻, (C₂F₂SO₂)₂N⁻, (C₂F₅SO₂)(CF₃SO₂)N⁻, and (CF₃SO₂)₂N⁻. For example, the ionic liquid may include at least one selected from N-methyl-N-propylpyrrolidium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide. A polymer ionic liquid may include a repeating unit including a) at least one cation selected from ammonium, pyrrolidinium, pyridinium, pyrimidium, imidazolium, piperidinium, pyrazolium, oxazolium, pyridazinium, phosphonium, sulfonium, triazolium, and any mixture thereof, and b) at least one anion selected from BF₄⁻, PF₆⁻, AsF₆⁻, SbF₆⁻, AlCl₄⁻, HSO₄⁻, ClO₄⁻, CH₃SO₃⁻, CF₃CO₂⁻, (CF₃SO₂)₂N⁻, (FSO₂)₂N⁻, Cl⁻, Br⁻, I⁻, SO₄⁻, CF₃SO₃⁻, (C₂F₅SO₂)₂N⁻, (C₂F₅SO₂)(CF₃SO₂) N⁻, NO₃⁻, Al₂Cl₇⁻, (CF₃SO₂)₃C⁻, (CF₃)₂PF₄⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂ (CF₃)₂CO⁻, (CF₃SO₂)₂CH⁻, (SF₅)₃C⁻, and (O(CF₃)₂C₂ (CF₃)₂O)₂PO⁻.

The ionic liquid electrolyte may be filled in pores formed on the surface of the solid electrolyte in contact with the cathode active material layer. An amount of the ionic liquid electrolyte may be about 0.1 parts by weight to about 20 parts by weight, about 0.1 parts by weight to about 15 parts by weight, about 0.1 parts by weight to about 10 parts by weight, or about 0.1 parts by weight to about 5 parts by weight based on 100 parts by weight of the cathode active material layer not including the ionic liquid electrolyte. Charging/discharging characteristics of batteries may be improved by increasing ionic conductivity by including the ionic liquid electrolyte.

The cathode active material layer may further include a conductive material and a binder. For example, the conductive material may include carbon black, carbon fiber, graphite, or any combination thereof. For example, the carbon black may be acetylene black, Ketjen black, super P carbon, channel black, furnace black, lamp black, thermal black, or any combination thereof. The graphite may be natural graphite or artificial graphite. Any combination including at least one of those described above may be used. The cathode active material layer may further include a conductive material including a composition other than that of the above-described conductive material. The additional conductive material may be conductive fiber such as metal fiber; metal powder such as carbon fluoride powder, aluminum powder, and nickel powder; conductive whisker such as zinc oxide and potassium titanate; polyethylene derivatives; or any combination thereof. An amount of the conductive material may be in a range of about 1 part by weight to about 10 parts by weight, for example, about 2 parts by weight to about 7 parts by weight based on 100 parts by weight of the cathode active material. When the amount of the conductive material is within this range, e.g., about 1 part by weight to about 10 parts by weight, electrical conductivity of the cathode may be appropriate.

The binder may improve adhesion between components of the cathode 50 and adhesion to the cathode current collector. Examples of the binder may include polyacrylic acid (PAA), polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butadiene-rubber, fluorinated rubber, a copolymer thereof, or any combination thereof. An amount of the binder may be in a range of about 1 part by weight to about 10 parts by weight, e.g., about 2 parts by weight to about 7 parts by weight based on 100 parts by weight of the cathode active material. When the amount of the binder is within this range, adhesion of the cathode active material layer to the cathode current collector is further improved, thereby inhibiting reduction of energy density of the cathode active material layer.

As a solvent, N-methylpyrrolidone, acetone, water, or the like may be used. The cathode active material, the conductive material, the binder, and the solvent may be used in amounts commonly used in lithium batteries.

A plasticizer may be added to the cathode active material composition to form pores inside the cathode active material layer.

The cathode 50 may further include a solid electrolyte. The solid electrolyte included in the cathode layer 50 may be similar to or different from the solid electrolyte included in the solid electrolyte 40. For detailed descriptions of the solid electrolyte, refer to the above described solid electrolyte. The solid electrolyte included in the cathode 50 may be, for example, a sulfide-based solid electrolyte. The sulfide-based solid electrolyte may be a sulfide-based solid electrolyte used in solid electrolytes 40.

Method of Preparing all-Solid-State Battery

A method of preparing an all-solid state battery according to an embodiment includes:
applying an interlayer to a substrate and drying the interlayer to provide an interlayer structure;
forming a cathode/solid electrolyte/interlayer structure by sequentially stacking a cathode, a solid electrolyte, and the interlayer structure, and performing a first pressing process to the stacked structure;
providing an electroformed three-dimensional (3D) porous current collector including a plurality of voids having a depth H and a radius R, the voids spaced apart from one another by interval P, and an insulator layer disposed on the interval between the plurality of voids;
removing the substrate from the cathode/solid electrolyte/interlayer structure to provide an exposed surface of the interlayer; and
arranging the electroformed current collector with the insulator layer (and openings of the voids) facing the exposed surface of the interlayer, and performing a second pressing process.

The anode includes a three-dimensional (3D) porous current collector including a plurality of voids having a depth H and a radius R, the voids spaced apart (offset) from one another by an interval P, wherein the plurality of voids provide space for lithium during charge, and provide lithium during discharge, where such voids are absent of lithium before charging or after complete discharge. The anode also includes an insulating layer disposed on a surface of the porous current collector proximate to the interlayer. The porous current collector is arranged above with the surface that includes the voids (void openings) facing the interlayer.

As prepared, and prior to any charging of a battery the plurality of voids do not include lithium. Moreover, after a complete or near-complete discharge of a battery the plurality of voids include little, if any, lithium.

The insulating layer is disposed on a surface between the plurality of voids, upper areas of the plurality of voids, and a portion of the insulating layer is in contact with the interlayer, and a portion of the plurality of voids may include the interlayer. The depth H, the radius R, and the interval P of the plurality of voids satisfy a relationship of Expression 1 below:

$$P \leq H \leq 50 P . \qquad Expression 1$$

An all-solid state battery prepared by the method according to an embodiment may operate over an extended time and over multiple charge/discharge cycles by suppressing or minimizing a pressure variation thereby reducing a stress level during charge/discharge cycles, and yet, the battery maintains excellent and acceptable charging/discharging characteristics and performance.

First, a cathode, a solid electrolyte, and an interlayer structure are prepared.

For the preparation of the cathode, chemical components constituting a cathode active material layer, i.e., a cathode active material and a binder, are added to a solvent, e.g., a non-aqueous solvent, to prepare a slurry. The prepared slurry is applied onto a cathode current collector and dried to prepare a cathode. The cathode may then be further impregnated with an electrolytic solution.

The solid electrolyte may be prepared, for example, by mixing or combining a sulfur precursor powder (e.g.: Li₂S), phosphorus precursor powder (e.g.: P₂S₅), and lithium-halogen precursor powder (e.g.: LiCl), and drying the mixture. The mixing or combining may include, for example, milling such as ball milling or pulverizing. During ball milling, stirring hours may be 3 hours or more, 6 hours or more, 8 hours or more, 10 hours or more, 12 hours or more, 14 hours or more, or 24 hours or more, and stirring rates may be 300 rpm or more, 400 rpm or more, 500 rpm or more, 600 rpm or more, 700 rpm or more, and 800 rpm or more. Alternatively, the solid electrolyte may be prepared by heat-treating a mixture prepared by adding a small amount of a solvent to the sulfur precursor powder (e.g.: Li₂S), the phosphorus precursor powder (e.g.: P₂S₅), and the lithium-halogen precursor powder (e.g.: LiCl), and drying the mixture. A heat treatment temperature may be about 350° C. to about 650° C. The drying may be performed at about room temperature to about 200° C. for about 1 minute to about 10 hours by vacuum drying, thermal drying, or thermal drying under vacuum conditions. Specifically, drying may be performed at 80° C. for 1 hour in a vacuum oven. The dried product after heat treatment may be mixed with a binder solution and formed into a self-standing film or pellets, or may be simply pressed into pellets with a thickness of several hundred micrometers. While being pressed, the product may be pressed with a pressure of about 50 MPa to about 400 MPa. The pressing may be performed at a pressure of at least 50 MPa, 55 MPa, 60 MPa, 65 MPa, 70 MPa, 75 MPa, 80 MPa, 85 MPa, 90 MPa, 95 MPa, or 100 MPa but not more than 200 MPa, 210 MPa, 220 MPa, 230 MPa, 240 MPa, 250 MPa, 260 MPa, 270 MPa, 280 MPa, 290 MPa, 300 MPa, 310 MPa, 320 MPa, 330 MPa, 340 MPa, 350 MPa, 360 MPa, 370 MPa, 380 MPa, 390 MPa, or 400 MPa. To prevent side reactions with oxygen and moisture, the product in the form of pellets may be calcined under an inert atmosphere. The calcination may be performed in a temperature range of about 350° C. to about 600° C. The calcination temperature may be maintained for about 1 hour to about 24 hours.

The interlayer structure is prepared by applying an interlayer composition to a substrate followed by drying. The interlayer composition may be prepared by preparing a slurry by mixing component materials described herein in an anode and a binder material for about 10 minutes to about 1 hour. After applying the prepared slurry to a substrate and drying the slurry at room temperature for about 30 minutes to about 2 hours, the product is vacuum dried at a temperature of about 100° C. to about 120° C. for about 1 hour to about 3 hours to form an interlayer with a thickness of about 1 μm to about 10 μm, thereby providing an interlayer structure.

Subsequently, the cathode, the solid electrolyte, and the interlayer structure are sequentially stacked and a first pressing process is performed to prepare a cathode/solid electrolyte/interlayer structure. For example, a pressure of 150 MPa or more may be applied during the first pressing process. Pressure applied during the pressing process may be, for example, 250 MPa or more. The pressure applied during the pressing process may be, for example, 1000 MPa or less, e.g., about 150 MPa to about 10,000 MPa, about 300 MPa to about 5,000 MPa, or about 500 MPa to about 2,000 MPa. A pressing time may be 10 minutes or less. For example, the pressing time may be about 5 milliseconds (ms) to about 10 minutes (min). For example, the pressing time may be about 2 min to about 7 min.

The pressing may be performed, for example, at room temperature (25° C.). For example, the pressing may be performed in a range of about 15° C. to about 25° C. However, the pressing temperature and times are not limited thereto and the pressing temperature may be about 25° C. to about 90° C., or 100° C. or more, for example, a high temperature of about 100° C. to about 500° C.

The pressing may be, for example, roll pressing, uni-axial pressing, flat pressing, warm isotactic pressing (WIP), or cold isotactic pressing (CIP), but is not limited thereto, any may be any pressing commonly used in the art.

Such an interlayer structure may effectively enlarge or increase storage for the plating of lithium in the plurality of voids of the 3D porous current collector during charging.

Subsequently, the all-solid-state battery having the cathode/solid electrolyte/anode structure may be prepared by using the above-described anode and a 3D porous current collector prepared by an electroforming method by removing the substrate from the cathode/solid electrolyte/interlayer structure. The prepared anode is then arranged with the insulator layer facing the exposed surface of the interlayer following the removal of the substrate. A second pressing process on the now stacked 3D porous current collector disposed on the interlayer of the cathode/solid electrolyte/interlayer is conducted.

The plurality of voids are formed by the electroforming method including the following processes: a process of preparing a conductive substrate, a process of applying a photoresist composition to the conductive substrate to form a photoresist film, a process of arranging a photomask having a certain pattern on the photoresist film, a process of exposing at least a portion of the photoresist film using energy rays, a process of developing the exposed photoresist film using a developer, a process of forming a metal layer by plating metal ions on the surface of the conductive substrate by locating a model with a pattern in an electrolytic bath, and applying a voltage thereto. The metal layer is then peeled from the conductive substrate after a thickness of the metal layer reaches a preset level to obtain a pattern that reverses the shape of the model, i.e., plurality of voids.

A method of depositing the insulating layer may be any deposition metal available in the art, without limitation, and may be, for example, chemical vapor deposition (CVD) or physical vapor deposition (PVD).

The second pressing process of the 3D porous current collector on the interlayer may be performed by using the same method as that of the first pressing process, but at a pressure lower than that of the first pressing process. The pressure applied during the pressing process may be, for example, about 100 MPa to about 5,000 MPa or about 200 MPa to about 2,000 MPa. A pressing time may be 10 minutes or less. For example, the pressing times may be 5 milliseconds (ms) to about 10 minutes (min). For example, the pressing time may be about 2 min to about 7 min.

Hereinafter, the disclosure will be described in more detail with reference to the following examples and comparative examples. However, the following examples are merely presented to exemplify the disclosure, and the scope of the disclosure is not limited thereto.

### EXAMPLES

### Example 1: Preparation of all-Solid-State Secondary Battery

A cathode slurry was prepared by mixing LiNi_{0.7}Co_{0.15}Al_{0.15}O₂(NCA) (D50=12 μm) as a cathode active material, carbon nanofiber as a conductive material, and Li₆PS₅Cl (D50=5 μm) as a solid electrolyte, and adding xylene to the mixture. The prepared cathode slurry was formed in the form of sheet to prepare a cathode sheet. A mixing weight ratio of the cathode active material:the conductive material:the sulfide-based solid electrolyte was 85:2:15. A cathode sheet (thickness: about 130 μm) was used as a cathode. A cathode capacity was about 3.5 mAh/cm².

A self-standing film formed of a Li₆PS₅Cl sulfide-based solid electrolyte with a thickness of 50 μm was used as a solid electrolyte.

3 g of carbon black (CB) having a particle diameter of about 38 nm as a carbonaceous material was mixed with 1 g of silver (Ag) particles having an average particle diameter of about 60 nm. To this mixture was added a mixture obtained by mixing 2.692 g of a PVDF binder solution (Solvay Specialty Polymers. Solef 5130) with 7 g of N-methyl-2-pyrrolidone (NMP). The resulting combined mixture was stirred at 2000 rpm for 30 minutes to prepare a slurry. After applying the slurry to an SUS substrate, the slurry was dried at room temperature for 1 hour and then vacuum dried at 120° C. for 2 hours to form an interlayer with a thickness of about 9 μm, thereby preparing an interlayer structure.

A 3D porous current collector having a plurality of voids prepared by an electroforming method, having a depth H and an inner radius R, and spaced apart from each other by a predetermined interval P (H: 20 μm, R: 10 μm, and P: 20 μm, manufactured by YOUNGJIN ASTECH Co., Ltd.), and using CVD an SiO₂ insulating layer (thickness: 60 nm) was deposited on the top of the intervals P between the plurality of voids.

Preparation of all-Solid-State Secondary Battery

After sequentially stacking the cathode, the solid electrolyte, and the interlayer structure, a first pressing process was performed by using a warm isostatic press (WIP) at 500 MPa at room temperature to prepare a cathode/solid electrolyte/interlayer structure.

The SUS substrate was removed from the cathode/solid electrolyte/interlayer structure. The 3D porous current collector was disposed on an opposite surface of the interlayer not in contact with the solid electrolyte, and a second pressing process was performed thereon by using a warm isostatic press (WIP) at 200 MPa at room temperature to prepare an all-solid-state secondary battery having a cathode/solid electrolyte/anode (interlayer/3D porous current collector) structure.

### Comparative Example 1: All-Solid-State Secondary Battery

An all-solid-state secondary battery was prepared in the same manner as in Example 1, except that an all-solid-state secondary battery having a cathode/solid electrolyte/interlayer structure was prepared by sequentially stacking the cathode, the solid electrolyte, and the interlayer structure and performing a first pressing process by using a warm isostatic press (WIP) at 500 MPa at room temperature.

### Comparative Example 2: All-Solid-State Secondary Battery

An all-solid-state secondary battery was prepared in the same manner as in Example 1, except that an all-solid-state secondary battery having a cathode/solid electrolyte/anode (interlayer/3D porous current collector) structure was prepared by using a 3D porous current collector (H: 20 μm, R: 10 μm, and P: 20 μm, manufactured by YOUNGJIN ASTECH Co., Ltd.) not including the SiO₂ insulating layer and disposed on an interlayer.

### Comparative Example 3: All-Solid-State Secondary Battery

An all-solid-state secondary battery was prepared in the same manner as in Example 1, except that an all-solid-state secondary battery having a cathode/solid electrolyte/anode (interlayer/3D porous current collector) structure was prepared by using a 3D porous current collector (H: 20 μm, R: 10 μm, P: 20 μm, and thickness of SiO₂-coated on P: 60 nm, manufactured by YOUNGJIN ASTECH Co., Ltd.) disposed on a Li₆PS₅Cl sulfide-based solid electrolyte and not including the interlayer.

### Evaluation Example 1: SEM-EDS Analysis

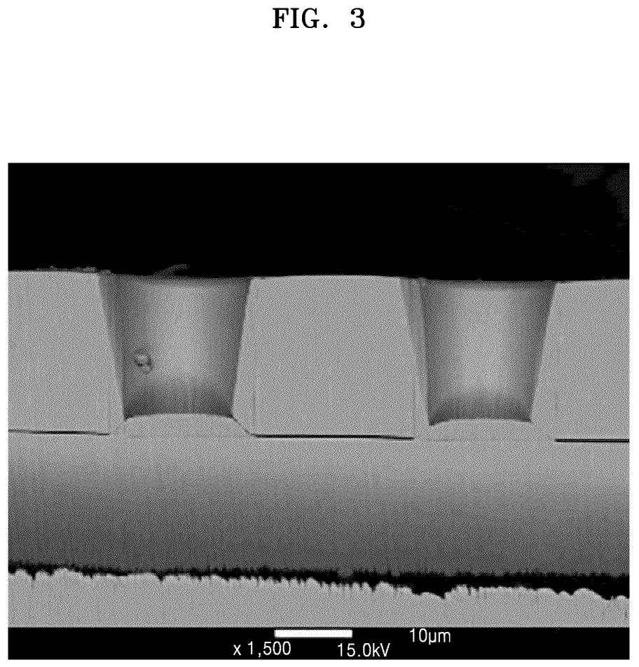

The all-solid-state secondary battery prepared in Example 1 was disassembled before the battery was charged. A Scanning Electron Microscope/Energy Dispersive X-Ray Spectroscopy (SEM/EDS) was performed on the anode. SEM-EDS analysis was performed by using an S-4700 FE-SEM (Hitachi) in the secondary electron (SE) mode, with an energy of 15.0 kV, and with 1,500× magnifications. The results are shown in FIGS. 3, 4, 5, and 6.

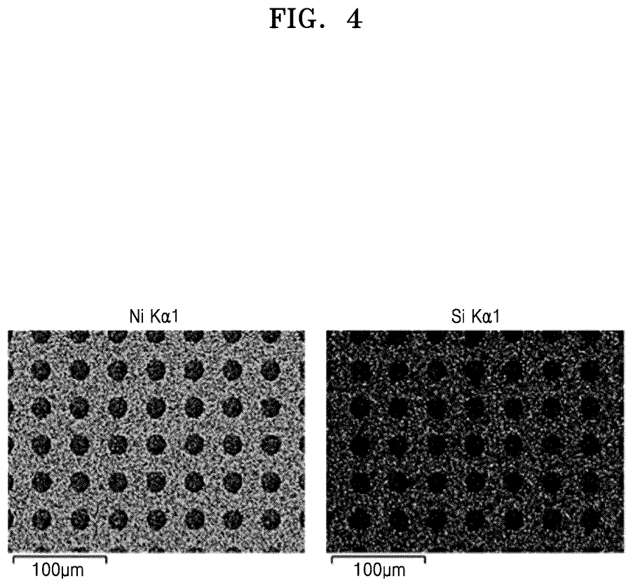

FIG. 3 is an enlarged scanning electron microscope (SEM) image of a 3D porous current collector of an anode of an all-solid-state secondary battery prepared in Example 1 before charging, and FIG. 4 is an EDS analysis image of the 3D porous current collector of FIG. 3 viewed from the top.

Referring to FIG. 3, before charging, the 3D porous current collector has a plurality of voids spaced apart from one another at an interval P. A horizontal circular-shaped cross-section of the 3D porous current collector has a cylindrical shape, which, for example, can have a tapered cross-sectional shape with a relatively wider top (opening of the void) than bottom (floor of the void). As shown, there is no lithium contained in the void. Referring to FIG. 4, nickel (Ni) was observed in the 3D porous current collector, and silicon (Si) was observed in the insulating layer disposed on the top of the intervals P between and around the plurality of voids.

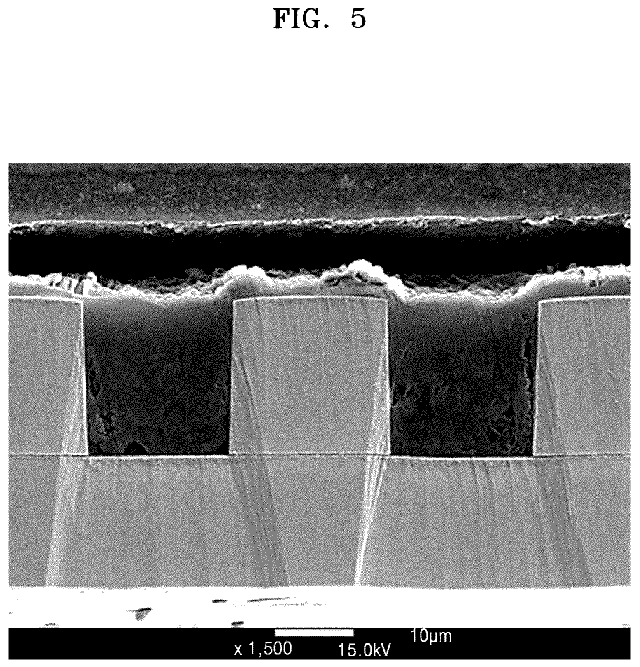

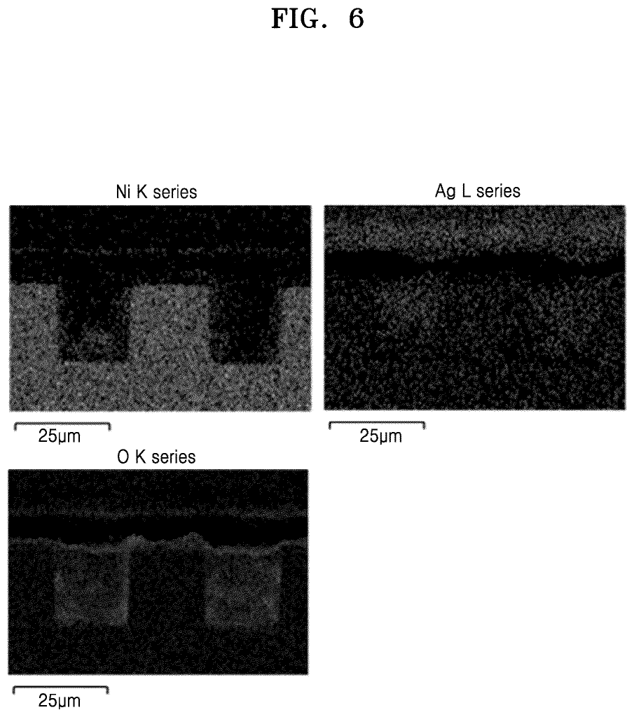

FIG. 5 is an enlarged SEM image of an interlayer/3D porous current collector as an anode of the all-solid-state secondary battery prepared in Example 1 after the battery is completely charged. FIG. 6 is an EDS image showing the interlayer/3D porous current collector structure of FIG. 5.

Referring to FIG. 5, lithium is present in the plurality of voids of the 3D porous current collector after the battery was completely charged. Referring to FIG. 6, it was confirmed that the 3D porous current collector included nickel (Ni), the interlayer and plurality of voids included silver (Ag), and oxygen (O) was present in the plurality of voids because lithium in the plurality of voids is oxidized due to high reactivity with air.

### Evaluation Example 2: Charging/Discharging Test and Pressure Variations

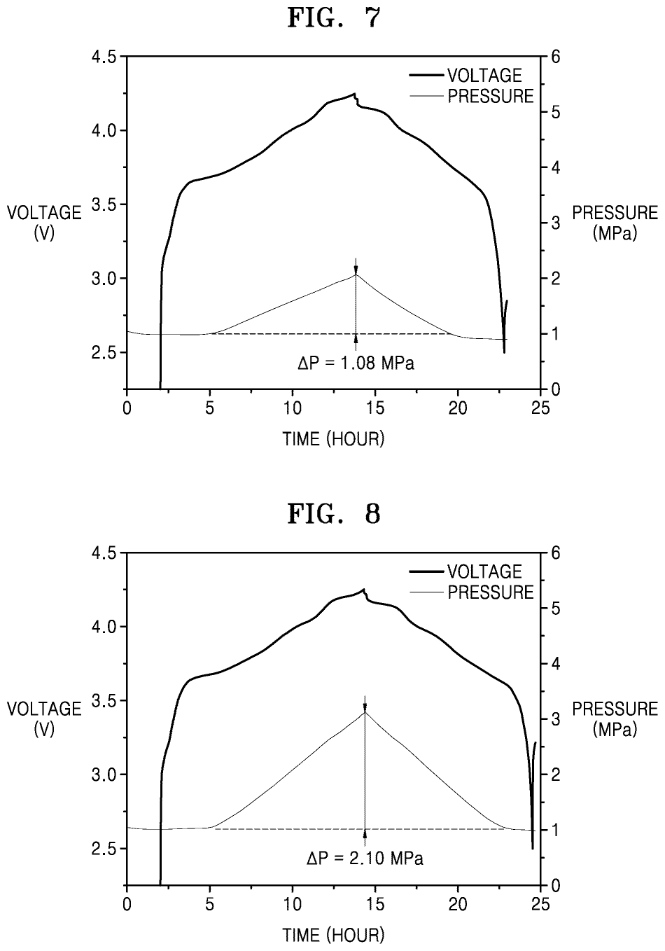

The coulombic efficiency and pressure variations of the all-solid-state secondary batteries prepared according to Example 1 and Comparative Examples 1 to 3 were evaluated according to the following method. The results are shown in Table 1 and FIGS. 7, 8, 9, and 10.

After fastening the all-solid-state secondary battery to a jig coupled to a load cell, the coulombic efficiency and a pressure variation (internal stress variation) were determined by a charging/discharge test including charging to a charging terminal voltage of 4.25 V under environmental conditions of 45° C. and 1 MPa at a charging current of 0.1 C, and discharging to a discharging terminal voltage of 2.5 V at a discharge current of 0.1 C. The coulombic efficiency was calculated by Expression 2 below.

$$Coulombic efficiency ( \% ) = [ ( discharging capacity at 0.1 C / charging capacity at 0.1 C ) \times 100 ] \qquad Expression 2$$

TABLE 1

| | Category | | | |
|---|---|---|---|---|
| | Discharging | Charging | Coulombic | Pressure |
| | capacity | capacity | efficiency | variation |
| | (@0.1 C) | (@0.1 C) | (%) | (ΔP, MPa) |
| Example 1 | 239.5 | 186.3 | 77.8 | 1.08 |
| Comparative | 243.11 | 197.94 | 81.4 | 2.10 |
| Example 1 | | | | |
| Comparative | 237.5 | 193.62 | 81.6 | 2.79 |
| Example 2 | | | | |
| Comparative | 249.6 | 206.9 | 82.9 | 3.65 |
| Example 3 | | | | |

Referring to Table 1 and FIGS. 7 to 10, the all-solid-state secondary battery prepared in Example 1 showed a pressure variation that is significantly lower than that of the all-solid-state secondary batteries prepared in Comparative Examples 1, 2, and 3. As confirmed, the all-solid-state secondary battery prepared in Example 1 exhibits a pressure variation that is two to four time (2.6 times and 3.4 times) less than that of Comparative Examples 2 and 3, respectively.

Referring to FIG. 7, the all-solid-state secondary battery of Example 1 exhibits a relatively low pressure variation.

Referring to FIG. 8, the all-solid-state secondary battery prepared in Comparative Example 1 exhibits a greater increase in pressure variation than Example 1.

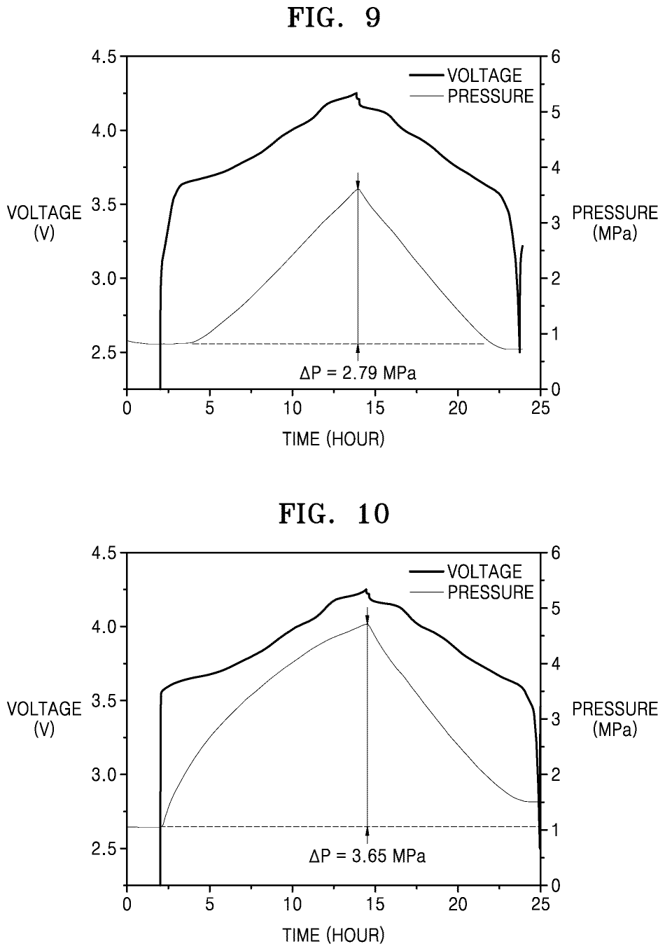

Referring to FIG. 9, the all-solid-state secondary battery prepared in Comparative Example 2 exhibited rapid increase in pressure due to the growth of lithium dendrites caused by the tip effect of the 3D porous current collector not including the SiO₂ insulating layer.

Referring to FIG. 10, the all-solid-state secondary battery prepared in Comparative Example 3 not including the interlayer showed a nonlinear pressure variation pattern, which indicates that lithium is plated substantially in non-void areas from the beginning (the onset) of the charge cycle.

In summary, it was confirmed that an all-solid-state secondary battery including each of the interlayer, the insulating layer, and the 3D porous current collector had very low pressure variations.

### Evaluation Example 3: Depth H and Inner Radius R of Voids, Interval P Therebetween, and Lithium Filling Quantity in 3D Porous Current Collector

In the 3D porous current collector of the all-solid-state secondary battery prepared in Example 1, the depths H and the inner radius R of the voids, intervals P between the plurality of voids (FIGS. 1B and 1C), and filling quantity of lithium plated in the voids were evaluated according to the following method.

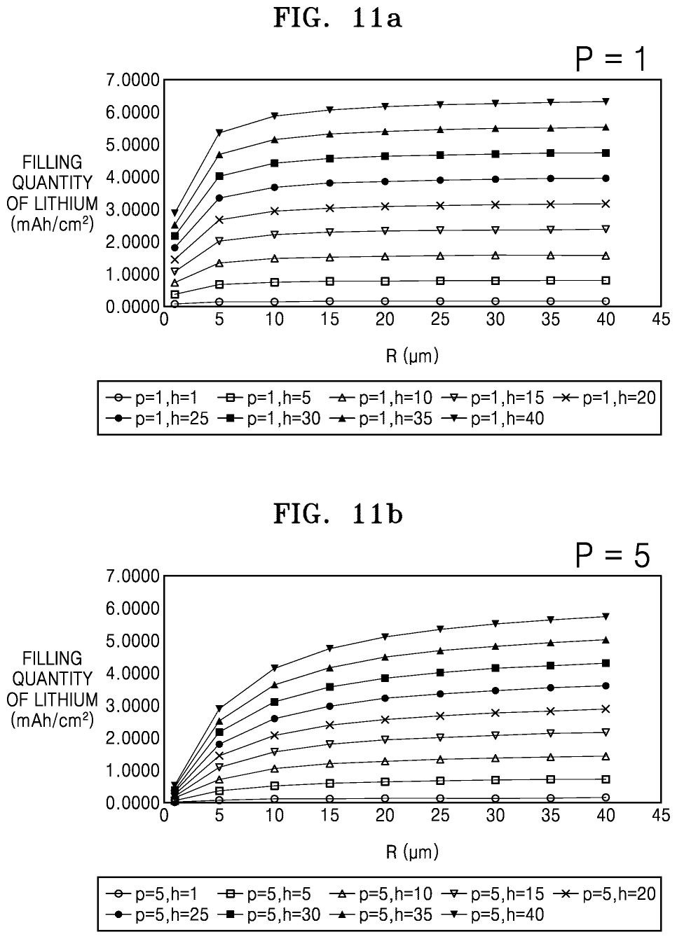

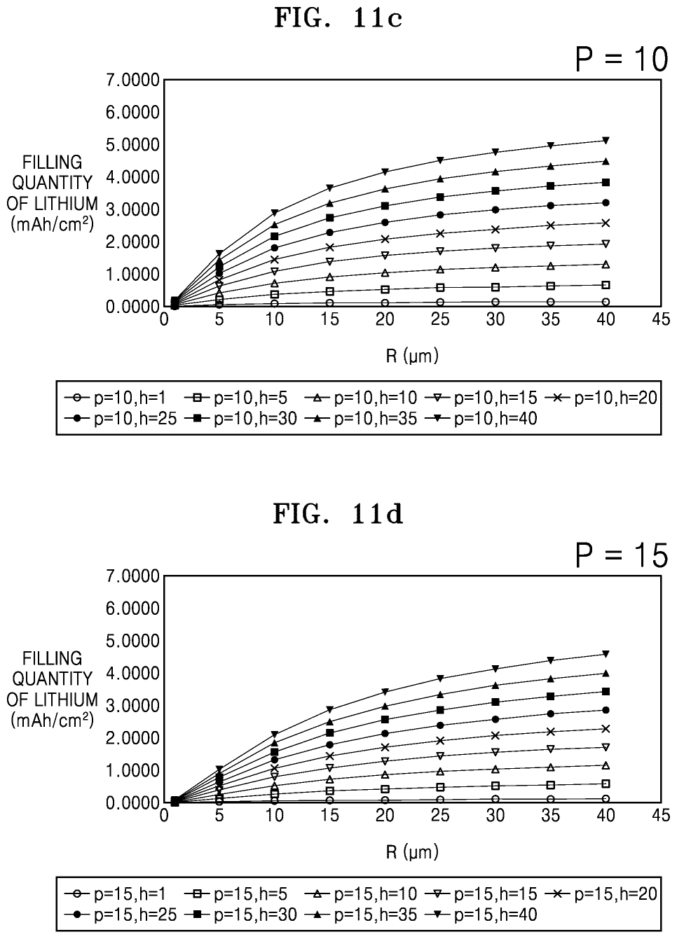

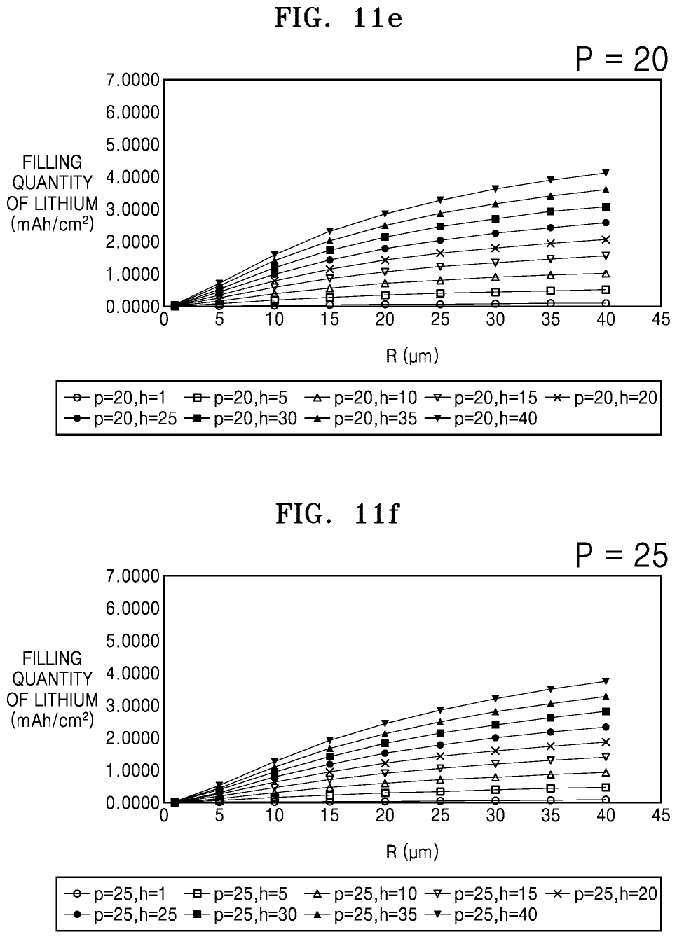

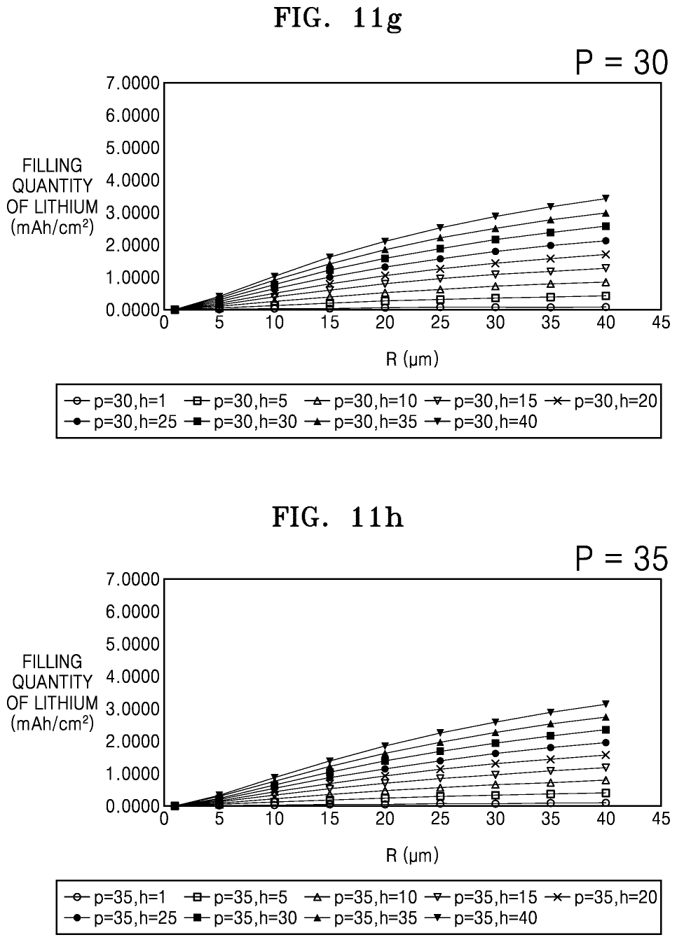

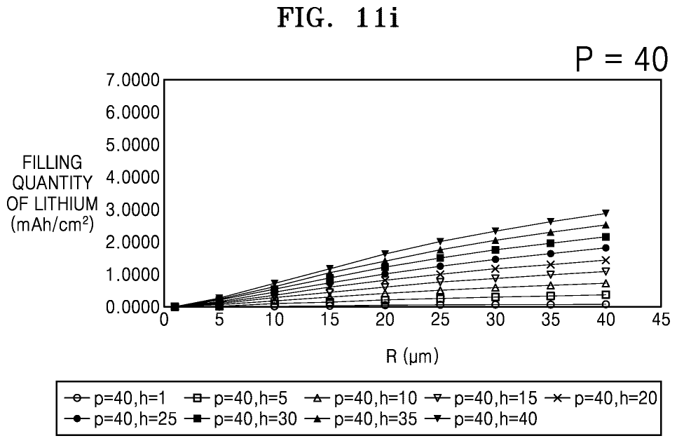

The number of voids in an electrode area of 1 cm² was calculated based on a given interval P between the plurality of voids of the 3D porous current collector shown in FIG. 1B and the radius R of the voids. Then, a volume per void was calculated by combining a given interval P between the plurality of voids, for example, P is 1, 5, 10, 15, 20, 25, 30, 35, and 40 with varying depth H (H is 1, 5, 10, 15, 20, 25, 30, 35, and 40) and varying radius R of the voids (R is 1, 5, 10, 15, 20, 25, 30, 35, and 40). The lithium filling quantity was calculated by Expression 3 below by using a volume per void. The results of which are shown as plots in FIGS. 11A to 11I.

$$Lithium filling quantity ( mAh / {cm}^{2} ) = [ \text{} crystallographic density of Li ( g / {cm}^{3} ) \times theoretical capacity of Li ( mAh / g ) \times volume per void ( {cm}^{3} ) \times total number of voids ] per electrode area ( {cm}^{2} ) \qquad Expression 3$$

In Expression 3,
the crystallographic density of Li (g/cm³) was 0.534 g/cm³, and
the theoretical capacity of Li (mAh/g) was 3,861 mAh/g.

Referring to FIGS. 11A to 11I, the all-solid state secondary battery prepared in Example 1 confirms that the filling quantity of lithium increased as the interval P between the plurality of voids of the 3D porous current collector decreased, the radius R of the voids increased, and the depth H increased.

The all-solid state secondary battery prepared in Example 1 satisfied the relationship shown in Expression 1 below among the interval P of the plurality of voids of the 3D porous current collector and the radius R and the depth H of the voids.

$$P \leq H \leq 50 P \qquad Expression 1$$

The anode and the all-solid state battery exhibit stable operation over time and/or charge/discharge cycles by suppressing or minimizing a pressure variation to relatively low levels, in some instances to a pressure variation near zero, and yet, the battery exhibits minimal change to charging/discharging characteristics or other operating conditions.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An anode comprising:
a three-dimensional (3D) porous current collector including a plurality of voids having a depth H and a radius R and spaced apart from one another by interval P, and an insulator layer disposed on the interval between the plurality of voids; and
an interlayer disposed on the 3D porous current collector,
wherein the plurality of voids provide space for lithium during charge, and provide lithium during discharge, where such voids are absent of lithium before charging or after complete discharge,
an area of the plurality of voids and a portion of the insulating layer are in contact with the interlayer,
at least a portion of the plurality of voids includes the interlayer, and
the depth H and the interval P of the plurality of voids satisfy Expression 1:
P≤H≤50P. Expression 1

2. The anode of claim 1, wherein the insulating layer s a insulating layer for lithium and electrons, and
comprises a material with an energy band gap of 3 eV or more.

3. The anode of claim 1, wherein the insulating layer comprises at least one of SiO₂, MgO, Al₂O₃, CaO, ZrSiO₄, ZrO₂, HfO₂, HfSiO₄, Y₂O₃, La₂O₃, Si₃N₄, SrO, or Ta₂O₅.

4. The anode of claim 1, wherein a thickness of the insulating layer is about 5 nm to about 100 nm.

5. The anode of claim 1, wherein the depth H of the plurality of voids is about 1 μm to about 90 μm.

6. The anode of claim 1, wherein the radius R of the plurality of voids is about 1 μm to about 40 μm.

7. The anode of claim 1, wherein the interval P of the plurality of voids is about 1 μm to about 40 μm.

8. The anode of claim 1, wherein the plurality of voids provide a micropattern in which the voids are consistently spaced apart by interval P, and
a horizontal cross-section of the micropattern has a circular, oval, triangular, square, rectangular, or hexagonal shape.

9. The anode of claim 1, wherein the 3D porous current collector comprises copper, nickel, aluminum, stainless steel, titanium, iron, cobalt, chromium, or an alloy thereof and, other than a natural oxide layer, there is no additional metal oxide or alloy oxide layer present on a surface of the 3D porous current collector.

10. The anode of claim 1, wherein the 3D porous current collector has a foil, foam, or mesh form.

11. The anode of claim 1, wherein a thickness of the 3D porous current collector is about 5 μm to about 100 μm.

12. The anode of claim 1, wherein the interlayer comprises a mixture, complex, or combination of a carbonaceous material and one of a metal or a metalloid.

13. The anode of claim 12, wherein the carbonaceous material comprises amorphous carbon, and
the metal or the metalloid comprises indium, silicon, gallium, tin, aluminum, titanium, zirconium, niobium, germanium, antimony, bismuth, gold, platinum, palladium, magnesium, silver, zinc, nickel, iron, cobalt, chromium, cesium, sodium, potassium, calcium, yttrium, tantalum, hafnium, barium, vanadium, strontium, lanthanum, or a combination thereof.

14. The anode of claim 1, wherein a thickness of the interlayer is about 1 μm to about 20 μm.

15. An all-solid-state battery comprising a cathode, an anode of claim 1, and a solid electrolyte disposed between the cathode and the anode.

16. The all-solid-state battery of claim 15, wherein a pressure variation of the all-solid-state secondary battery during charging or discharging at 45° C. at 0.1 C in a voltage range of 2.5 V to 4.25 V is about 0.001 MPa to about 1.5 MPa.

17. A method of preparing an all-solid-state battery, the method comprising:
applying an interlayer to a substrate and drying the interlayer to provide an interlayer structure;
forming a cathode/solid electrolyte/interlayer structure by sequentially stacking a cathode, a solid electrolyte, and the interlayer structure, and performing a first pressing process to the stacked structure; and
providing an electroformed three-dimensional (3D) porous current collector including a plurality of voids having a depth H and a radius R, the voids spaced apart from one another by interval P, and an insulator layer disposed on the interval between the plurality of voids,
wherein the depth H and the interval P of the plurality of voids satisfy Expression 1:
P≤H≤50P; Expression 1
removing the substrate from the cathode/solid electrolyte/interlayer structure to provide an exposed surface of the interlayer; and
arranging the electroformed current collector with the insulator layer facing the exposed surface of the interlayer; and performing a second pressing process.

18. The method of claim 17, wherein the plurality of voids arranged in a micro-pattern in which the voids are consistently spaced apart by interval P,
the insulating layer comprises a material with an energy band gap of 3 eV or more, and
a horizontal cross-section of the micropattern has a circular, oval, triangular, square, rectangular, or hexagonal shape.

19. The method of claim 17, wherein the first pressing process and the second pressing process are performed by using an isostatic press, and
pressure applied during the first pressing process is greater than pressure applied during the second pressing process.

20. The method of claim 17, wherein the 3D porous current collector comprises copper, nickel, aluminum, stainless steel, titanium, iron, cobalt, chromium, or an alloy thereof, and for an exception of a natural oxide layer, there is no additional metal oxide or alloy oxide layer present on a surface of the 3D porous current collector.
